(19) United States
(12) Patent Application Publication
(10) Pub. No.: US 2026/0273905 A1
(43) Pub. Date: Sep. 17, 2026

(54) MULTILAYER FILM, VAPOR-DEPOSITED MULTILAYER FILM, MULTILAYER STRUCTURE, PACKAGING MATERIAL, RECOVERY COMPOSITION, METHOD FOR RECOVERING MULTILAYER STRUCTURE, AND METHOD FOR MANUFACTURING MULTILAYER FILM

(71) Applicant: Kuraray Co., Ltd., Okayama (JP)

(72) Inventors: Satoshi ISHIUCHI, Kurashiki-shi, Okayama (JP); Rina HOSHIKA, Chiyoda-ku, Tokyo (JP)

(73) Assignee: Kuraray Co., Ltd., Okayama (JP)

(21) Appl. No.: 19/473,467

(22) PCT Filed: Apr. 11, 2024
(86) PCT No.: PCT/JP2024/014607

§ 371 Date: Oct. 7, 2025

(30) Foreign Application Priority Data
Apr. 12, 2023 (JP) 2023-064613

(51) Int. Cl. B32B 27/30; B32B 7/12; B32B 15/00; B32B 27/32; B32B 27/34; B32B 37/24; B32B 38/00

(52) U.S. Cl. CPC B32B 27/306; B32B 7/12; B32B 15/00; B32B 27/32; B32B 27/34; B32B 37/24; B32B 38/0012; B32B 2037/246; B32B 2038/0028; B32B 2250/02; B32B 2274/00; B32B 2307/7244; B32B 2307/7376

(57) ABSTRACT

The present disclosure provides a multilayer film including a layer (X) as an outermost layer; and at least one layer different from the layer (X).

### TECHNICAL FIELD

The present invention relates to a multilayer film, a vapor-deposited multilayer film, a multilayer structure, a packaging material including the multilayer structure, a recovered composition, and a recovering method.

### BACKGROUND ART

Packaging materials for long-term storage of foods or the like are often required to have gas barrier properties such as an oxygen barrier property. Oxidative degradation of foods or the like by oxygen penetration and/or propagation of microorganisms can be inhibited by using a packaging material having high gas barrier properties. As a layer which improves the gas barrier properties: a metal foil or a vapor-deposited metal layer of aluminum or the like; a vapor-deposited inorganic-oxide layer of a silicon oxide, an aluminum oxide, or the like; or the like has been widely used. On the other hand, a resin layer of a resin having gas barrier properties, such as a vinyl alcohol polymer or polyvinylidene chloride, has been also widely used. A vinyl alcohol polymer is characterized by gas barrier properties, which it exhibits through crystallization and densification by way of hydrogen bonding between hydroxy groups in its molecules. In particular, an ethylene-vinyl alcohol copolymer (hereinafter, may be abbreviated to “EVOH”) has superior thermal stability, and thus is suitable for melt forming. Thus, multilayer films including an EVOH layer as an intermediate layer have been widely used as gas barrier packaging materials as co-extrusion techniques have been developed (Patent Document 1).

Furthermore, in recent years, with the impetus of environmental issues and waste issues, there have been increasing worldwide demands for so-called post-consumer recycling, being the recovering and recycling of packaging materials that have been consumed on the market (hereinafter, may be simply abbreviated to recycling). In recycling, a process in which recovered packaging materials are cut and, as needed, sorted and washed, and then melted and mixed using an extruder is typically employed. Various formed products are produced using pellets thus obtained. In this regard, it is required that the packaging materials be composed of a single material as much as possible (monomaterialization), thereby enabling obtaining recycled resins having high purity and high quality. For this purpose, a demand for barrier films containing polyolefins, which are widely used as packaging materials, as a main material is increasing. For this purpose, in order to achieve extremely high gas barrier properties, a vapor-deposited multilayer film obtained by laminating a vapor-deposited inorganic layer to a surface of an EVOH layer of a polyolefin multilayer film including the EVOH layer as an outermost layer has been also proposed (Patent Document 2).

### PRIOR ART DOCUMENTS

### Patent Documents

Patent Document 1: PCT International Publication No. 2020/071513
Patent Document 2: PCT International Publication No. 2021/261560

### SUMMARY OF THE INVENTION

### Problems to be Solved by the Invention

When a multilayer film including a gas barrier resin layer as an outermost layer is produced by melt forming, the gas barrier resin having high metal affinity is likely to remain in the inside of the die and cause viscosity change and/or deterioration products, and also the gas barrier resin is likely to cause volume expansion at the die exit and come into contact with the die exit. Therefore, in a case in which the multilayer film including the gas barrier resin layer as an outermost layer is produced by melt forming, deposits (die buildup) may be generated at the die exit, and may adversely affect the quality of a multilayer film to be obtained. Furthermore, when the die buildup is generated, cleaning may be necessary to remove this die buildup. Additionally, when a vapor-deposited inorganic layer is laminated to a surface of the gas barrier resin layer of such a multilayer film, the gas barrier properties may become insufficient.

In view of such circumstances, a first object of the present invention is to provide: a multilayer film configured to inhibit the die buildup during the production and having superior gas barrier properties and recyclability; and a method for producing the multilayer film. A second object of the present invention is to provide, by using the multilayer film, a vapor-deposited multilayer film, a multilayer structure, and a packaging material including the multilayer structure, which have superior gas barrier properties and recyclability. A third object of the present invention is to provide a recovered composition containing a recovered material of the multilayer structure, and a method for recovering the multilayer structure.

### Means for Solving the Problems

As a result of thorough investigation into various combinations of resin formulations and laminated structures, the present inventors found that when a multilayer film including a gas barrier resin layer as an outermost layer is produced, using a gas barrier resin composition containing a specific polyolefin enables obtaining a multilayer film that is configured to enable inhibiting the die buildup during the production, and has superior gas barrier properties and recyclability. Furthermore, it was found that by using the multilayer film, a vapor-deposited multilayer film and a multilayer structure that have superior gas barrier properties and recyclability are obtained, and thus, the present invention was completed. More specifically, the above-described objects are achieved by providing the following:
(1) A multilayer film including: a layer (X) as an outermost layer; and at least one layer different from the layer (X), wherein the layer (X) is a layer consisting only of a resin composition (A) containing: at least one gas barrier resin (a) selected from the group consisting of a polyamide (hereinafter, may be abbreviated to “PA”) and a vinyl alcohol resin; and a polyolefin (b) having a melt flow rate of 3.0 g/10 min or more at 190° C. under a load of 2.160 kg, as measured in accordance with JIS K7210-1 (2014), and the resin composition (A) contains 0.1 parts by mass or more and 20 parts by mass or less of the polyolefin (b) with respect to 100 parts by mass of the gas barrier resin (a);
(2) The multilayer film according to (1), wherein the gas barrier resin (a) is at least one selected from the group consisting of nylon 6/66 and an EVOH;
(3) The multilayer film according to (1), wherein the gas barrier resin (a) is an EVOH having an ethylene unit content of 20 to 50 mol % and a degree of saponification of 90 mol % or more;
(4) The multilayer film according to any one of (1) to (3), wherein the polyolefin (b) has a melt flow rate of 10 g/10 min or more at 190° C. under a load of 2.160 kg, as measured in accordance with JIS K7210-1 (2014);
(5) The multilayer film according to any one of (1) to (4), wherein the polyolefin (b) is an ethylene-vinyl acetate copolymer (hereinafter, may be abbreviated to “EVA”) having an ethylene unit content of 75 to 98 mol % or a saponified product thereof;
(6) The multilayer film according to (5), wherein the polyolefin (b) is the saponified product of the EVA, and the saponified product has a degree of saponification of 30 mol % or more;
(7) The multilayer film according to any one of (1) to (6), wherein a number-average molecular weight (Mn) of the polyolefin (b) is 3,000 to 25,000;
(8) The multilayer film according to any one of (1) to (7), wherein the resin composition (A) contains an alkali metal ion (c) at a concentration of 40 ppm or more and 500 ppm or less;
(9) The multilayer film according to any one of (1) to (8), wherein the resin composition (A) contains at least one type of multivalent metal ion (d) selected from the group consisting of a magnesium ion, a calcium ion, and a zinc ion, at a concentration of 20 ppm or more and 2,000 ppm or less;
(10) The multilayer film according to any one of (1) to (9), wherein the layer (X) is a layer obtained by melt forming pellets consisting only of the resin composition (A);
(11) The multilayer film according to any one of (1) to (10), including a layer (Y) and a layer (Z) as the layer different from the layer (X), wherein the layer (Y) contains as a principal component, an adhesive resin (B) having a melting point of less than 170° C.; the layer (Z) contains as a principal component, a polyolefin resin (C) having a melting point of less than 170° C.; and the multilayer film has a configuration in which the layer (X), the layer (Y), and the layer (Z) are laminated in this order;
(12) The multilayer film according to (11), wherein the adhesive resin (B) is an acid-modified polyethylene or an acid-modified polypropylene;
(13) The multilayer film according to (11), wherein the polyolefin resin (C) is a polyethylene or a polypropylene;
(14) The multilayer film according to any one of (1) to (13), wherein in thermogravimetry (TG), a weight loss W of the resin composition (A) after being maintained at 200° C. for 30 minutes in a nitrogen atmosphere is 0.01 to 0.3%;
(15) The multilayer film according to any one of (1) to (14), not including: a layer containing as a principal component, a resin having a melting point of 200° C. or more; and a metal layer having an average thickness of 1 μm or more;
(16) The multilayer film according to any one of (1) to (15), wherein an average thickness of the layer (X) is 0.2 μm or more and less than 20 μm, and a proportion of the average thickness of the layer (X) with respect to an average thickness of the multilayer film is less than 25%;
(17) The multilayer film according to any one of (1) to (16), wherein the multilayer film is not stretched;
(18) The multilayer film according to any one of (1) to (16), wherein the multilayer film is only uniaxially stretched by 3 times or more and less than 12 times;
(19) The multilayer film according to any one of (1) to (16), wherein the multilayer film is biaxially stretched each by 3 times or more and less than 12 times;
(20) The multilayer film according to any one of (1) to (19), wherein a proportion of a total average thickness of a layer containing a polyethylene resin or a polypropylene resin as a principal component is 75% or more;
(21) A vapor-deposited multilayer film including: the multilayer film according to any one of (1) to (20); and a vapor-deposited inorganic layer (I) laminated to an exposed-face side of the layer (X) of the multilayer film;
(22) The vapor-deposited multilayer film according to (21), wherein the vapor-deposited inorganic layer (I) is: a vapor-deposited metal layer containing aluminum as a principal component; or a vapor-deposited inorganic-oxide layer containing alumina or silica as a principal component;
(23) The multilayer film or the vapor-deposited multilayer film according to any one of (1) to (22), having an oxygen transmission rate of less than 60 cc/(m²·day·atm), as measured in accordance with JIS K7126-2 (2006) under a condition involving 20° C. and 65% RH;
(24) A multilayer structure in which: the multilayer film or the vapor-deposited multilayer film according to any one of (1) to (23); and at least one resin layer (R) containing a thermoplastic resin (D) as a principal component are laminated;
(25) The multilayer structure according to (24), wherein the thermoplastic resin (D) is a polyethylene or a polypropylene;
(26) A packaging material including the multilayer structure according to (24) or (25); (27) A recovered composition containing a recovered material of the multilayer structure according to (24) or (25);
(28) A method for recovering a multilayer structure, the method including:
   melt forming the multilayer structure according to (24) or (25) after the multilayer structure is ground; and
(29) A method for producing the multilayer film according to any one of (1) to (20), the method including: melt kneading the gas barrier resin (a) and the polyolefin (b) to obtain pellets of the resin composition (A); and melt forming the pellets of the resin composition (A) to form the layer (X).

### Effects of the Invention

The present invention enables providing a multilayer film configured to inhibit the die buildup during the production and having superior gas barrier properties and recyclability. Furthermore, using the multilayer film enables providing a vapor-deposited multilayer film, a multilayer structure, and a packaging material including the multilayer structure that each have superior gas barrier properties and recyclability. Moreover, since the multilayer structure has favorable recyclability, it is possible to provide: a recovered composition containing a recovered material of the multilayer structure; and a method for recovering the multilayer structure. The “recyclability” as referred to herein means that when the recovered material of the multilayer structure or the packaging material of the present invention is melt kneaded to produce the recovered composition, gelation of the resin can be inhibited, and the recovered composition that has superior appearance can be efficiently produced. The recyclability can be evaluated by a recovering test described in the Examples. In addition, the “die buildup” as referred to herein means polymer deposits generated at the gas barrier layer side of the die exit.

### DESCRIPTION OF EMBODIMENTS

Hereinafter, embodiments of the present invention will be described. It is to be noted that in the following description, specific materials (compounds, etc.) may be exemplified as those that exhibit specific functions, but the present invention is not limited to a mode using such materials. Furthermore, unless otherwise specified, the materials exemplified may be used alone or in combination.

A multilayer film of the present invention includes: a layer (X) as an outermost layer; and at least one layer different from the layer (X), wherein the layer (X) is a layer consisting only of a resin composition (A) containing: at least one gas barrier resin (a) selected from the group consisting of a PA and a vinyl alcohol resin; and a polyolefin (b) having a melt flow rate of 3.0 g/10 min or more at 190° C. under a load of 2.160 kg, as measured in accordance with JIS K7210-1 (2014), and the resin composition (A) contains 0.1 parts by mass or more and 20 parts by mass or less of the polyolefin (b) with respect to 100 parts by mass of the gas barrier resin (a).

The at least one gas barrier resin (a) selected from the group consisting of a PA and a vinyl alcohol resin has superior gas barrier properties, and the multilayer film of the present invention including the layer (X) as an outermost layer can achieve high gas barrier properties. Furthermore, since the gas barrier resin (a) of the outermost layer has high affinity with a vapor-deposited inorganic layer (I) described later, high gas barrier properties tend to be able to be stably exhibited when the multilayer film is made into a vapor-deposited film of the present invention. On the other hand, there is a problem, which may result from high affinity of the gas barrier resin (a) with a metal surface of an extruder or the like, that die buildup is easily generated during production of the multilayer film, and it is difficult to achieve both production of the multilayer film containing the gas barrier resin (a) in the outermost layer, and stable manufacture with the die buildup being inhibited. Thus, as a result of thorough investigation by the present inventors, it was found that by using the resin composition (A) containing the polyolefin (b) having a melt flow rate of 3.0 g/10 min or more in accordance with JIS K7210-1 (2014) (190° C., load of 2.160 kg), slipping properties between the molten resin and the metal surface of the extruder or the like during production of the multilayer film are improved, and consequently the die buildup during the production is inhibited. In general, the die buildup is generated when the molten resin pressure received by the inside of the die is released at the die exit, thereby causing volume expansion, and the molten resin adheres to a die lip surface. The die buildup is not caused by heat deterioration due to, for example, retention in the extruder. The higher the stress received by the resin in the die is, the more likely the volume expansion at the die exit is to occur. It is considered that in the present invention, due to the layer (X), which is the outermost layer, containing the polyolefin (b), the frictional force between the gas barrier resin (a) having a polar group and a metal wall face in the die is reduced, a stress to be received by the gas barrier resin (a) decreases, and consequently, the volume expansion of the molten gas barrier resin (a) is inhibited, and an effect of reducing the die buildup is exhibited.

It is to be noted that the phrase “the layer (X), the layer (Y), and the layer (Z) are laminated adjacently in this order” as referred to herein means that the adjacent layers are directly laminated; specifically means that the layer (X), the layer (Y), and the layer (Z) are laminated in this order, the layer (X) and the layer (Y) are directly laminated, and the layer (Y) and the layer (Z) are directly laminated.

The “principal component” as referred to herein means a component that is contained in more than 50% by mass.

As referred to herein, the term “average thickness” of each layer, etc. means an average of thicknesses measured at any five places, unless otherwise specified.

The “ppm” as referred to herein means a content on mass basis (mass ppm).

The “polyethylene” as referred to herein means a homopolymer of ethylene, a copolymer of 80 mol % or more of ethylene and 20 mol % or less of an α-olefin monomer, and a copolymer of 90 mol % or more of ethylene and less than 10 mol % of a non-olefin monomer containing no atom other than a carbon atom, an oxygen atom, and a hydrogen atom in the functional group.

The “polypropylene” as referred to herein means a homopolymer of propylene, a copolymer of 80 mol % or more of propylene and 20 mol % or less of an α-olefin monomer, and a copolymer of 90 mol % or more of propylene and less than 10 mol % of a non-olefin monomer containing no atom other than a carbon atom, an oxygen atom, and a hydrogen atom in the functional group.

The “acid-modified polyethylene” as referred to herein means a polymer obtained by modifying polyethylene with an acid. The acid-modified polyethylene may be a polymer obtained by introducing at least one of an acidic group and an acidic anhydride group into the polyethylene.

The “acid-modified polypropylene” as referred to herein means a polymer obtained by modifying polypropylene with an acid. The acid-modified polypropylene may be a polymer obtained by introducing at least one of an acidic group and an acidic anhydride group into the polypropylene.

The “polyethylene resin” as referred to herein means the polyethylene and a modified polyethylene (such as the acid-modified polyethylene). The modified polyethylene as referred to herein means a polymer obtained by modifying the polyethylene.

The “polypropylene resin” as referred to herein means the polypropylene and a modified polypropylene (such as the acid-modified polypropylene). The modified polypropylene as referred to herein means a polymer obtained by modifying the polypropylene.

Furthermore, as referred to herein, the “surface (or outer layer)” of the multilayer film or the multilayer structure means an exposed face, not in the sense of distinguishing between the front and the back. In other words, the multilayer film and the multilayer structure each have two surfaces. Similarly, the multilayer film and the multilayer structure each have two outermost layers.

It is to be noted that “consisting substantially only of” as referred to herein means that optional component(s) is/are permitted to be contained within a range not influencing the effects of the present invention, and “consisting only of” as referred to herein means that optional component(s) other than impurities which are inevitably contained is/are excluded.

In addition, herein, numerical value ranges described using “to” mean that numerical values before and after “to” are included as the lower limit value and the upper limit value, respectively.

### Layer (X)

The multilayer film of the present invention includes the layer (X), as an outermost layer, consisting only of the resin composition (A) containing: the at least one gas barrier resin (a) selected from the group consisting of a PA and a vinyl alcohol resin; and the polyolefin (b) having a melt flow rate of 3.0 g/10 min or more in accordance with JIS K7210-1 (2014; 190° C., load of 2.160 kg). The resin composition (A) contains 0.1 parts by mass or more and 20 parts by mass or less of the polyolefin (b) with respect to 100 parts by mass of the gas barrier resin (a).

### Gas Barrier Resin (a)

The gas barrier resin (a) is at least one selected from the group consisting of a PA and a vinyl alcohol resin. Due to containing the gas barrier resin (a), the gas barrier properties of the multilayer film improve. Furthermore, since the gas barrier resin (a) has high affinity with the vapor-deposited inorganic layer (I) described later, the multilayer film of the present invention including as an outermost layer, the layer (X) consisting only of the resin composition (A) containing the gas barrier resin (a) enables easily providing the vapor-deposited inorganic layer (I) on the layer (X), and a vapor-deposited multilayer film including the vapor-deposited inorganic layer (I) tends to be able to stably exhibit favorable gas barrier properties.

Examples of the PA include polycaproamide (nylon 6), poly-ω-aminoheptanoic acid (nylon 7), poly-ω-aminononanoic acid (nylon 9), polyundecanamide (nylon 11), polylauryllactam (nylon 12), polyethylenediamine adipamide (nylon 26), polytetramethylene adipamide (nylon 46), polyhexamethylene adipamide (nylon 66), polyhexamethylene sebacamide (nylon 610), polyhexamethylene dodecamide (nylon 612), polyoctamethylene adipamide (nylon 86), polydecamethylene adipamide (nylon 106), a caprolactam/lauryllactam copolymer (nylon 6/12), a caprolactam/ω-aminononanoic acid copolymer (nylon 6/9), a caprolactam/hexamethylenediammonium adipate copolymer (nylon 6/66), a lauryllactam/hexamethylenediammonium adipate copolymer (nylon 12/66), an ethylene diammonium adipate/hexamethylenediammonium adipate copolymer (nylon 26/66), a caprolactam/hexamethylenediammonium adipate/hexamethylenediammonium sebacate copolymer (nylon 6/66/610), an ethylene diammonium adipate/hexamethylenediammonium adipate/hexamethylenediammonium sebacate copolymer (nylon 26/66/610), polyhexamethylene isophthalamide (nylon 6I), polyhexamethylene terephthalamide (nylon 6T), a hexamethyleneisophthalamide/hexamethyleneterephthalamide copolymer (nylon 6I/6T), a 11-aminoundecanamide/hexamethyleneterephthalamide copolymer, polynonamethylene terephthalamide (nylon 9T), polydecamethylene terephthalamide (nylon 10T), polyhexamethylene cyclohexylamide, and polynonamethylene cyclohexylamide, as well as those that are obtained by modifying these PAs with aromatic amines such as methylenebenzylamine and metaxylene diamine. Additionally, other examples include metaxylylenediammonium adipate and the like. Of these, in light of economic efficiency, melt formability, and mechanical properties each being superior, the PA is preferably nylon 6/66 or nylon 6, and in light of recyclability of the multilayer film, the PA is more preferably nylon 6/66.

The vinyl alcohol resin may be a polymer having a content (mol %) of a vinyl alcohol unit of more than 50 mol % with respect to total monomer units. The vinyl alcohol resin is exemplified by polyvinyl alcohol (hereinafter, may be abbreviated to “PVA”) and an ethylene-vinyl alcohol copolymer (EVOH). The vinyl alcohol resin is preferably an EVOH in light of melt formability, and more preferably an EVOH having an ethylene unit content of 20 to 50 mol % and a degree of saponification of 90 mol % or more in light of enabling enhancing particularly gas barrier properties, melt formability, and recyclability in a well balanced manner.

The PVA is typically a polymer obtained by saponifying a polyvinyl ester obtained by polymerizing a vinyl ester.

A viscosity average degree of polymerization of the PVA is preferably 400 or more and 2,000 or less. The lower limit of the viscosity polymerization degree is more preferably 500, and still more preferably 700. When the viscosity average degree of polymerization is more than or equal to the lower limit, adhesiveness and/or thermal stability of the PVA improve. The upper limit of the viscosity average degree of polymerization is more preferably 1,500, and still more preferably 1,000. When the viscosity average degree of polymerization is less than or equal to the upper limit, the melt formability of the PVA improves.

The viscosity average degree of polymerization of the PVA is measured in accordance with JIS K6726 (1994). Specifically, a limiting viscosity [η] (L/g) of the PVA is measured in water at 30° C., and the value of the limiting viscosity [η] is used to calculate the viscosity average degree P of polymerization by the following equation. It is to be noted that in a case in which the degree of saponification of the PVA is less than 99.5 mol %, the limiting viscosity [η] is measured after saponification is performed until the degree of saponification reaches 99.5 mol % or more.

$$P = {( [ η ] \times {10}^{4} / 8.29 )}^{( 1 / 0.62 )}$$

The degree of saponification of the PVA is preferably 70 mol % or more, more preferably 75 mol %, and still more preferably 85 mol % or more. The degree of saponification of the PVA is a proportion of the number of vinyl alcohol units with respect to a total number of vinyl alcohol units and vinyl ester units in the PVA. When the degree of saponification is 70 mol % or more, water solubility of the PVA is superior, and delamination properties in a separation step for the multilayer structure improve. The degree of saponification of the PVA is preferably 95 mol % or less, more preferably 93 mol % or less, and still more preferably 90 mol % or less. When the degree of saponification is 95 mol % or less, melt formability of the PVA is superior. The degree of saponification of the PVA is measured in accordance with JIS K6726 (1994).

A total of contents of a vinyl alcohol unit and a vinyl ester unit in total monomer units constituting the PVA is preferably 95 mol % or more. When the total of the contents is 95 mol % or more, water solubility of the PVA more improves, and consequently, separability of the multilayer structure more improves. The total of the contents of the vinyl alcohol unit and the vinyl ester unit is more preferably 97 mol % or more, still more preferably 98 mol % or more, and particularly preferably 99 mol % or more.

The PVA may contain a monomer unit other than the vinyl alcohol unit and the vinyl ester unit within a range not leading to impairment of the effects of the present invention. Such a monomer unit is exemplified by: α-olefins such as ethylene units, propylene, n-butene, and isobutylene; acrylic acid and salts thereof; acrylic acid esters; methacrylic acid and salts thereof; methacrylic acid esters; acrylamide; N-methylacrylamide, N-ethylacrylamide, N,N-dimethylacrylamide, diacetone acrylamide, acrylamide propanesulfonic acid and salts thereof, acrylamide propyldimethylamine and salts and quaternary salts thereof, N-methylolacrylamide and acrylamide derivatives such as derivatives of N-methylolacrylamide; methacrylamide; N-methyl methacrylamide, N-ethyl methacrylamide, methacrylamide propanesulfonic acid and salts thereof, methacrylamidepropyldimethylamine and salts and quaternary salts thereof; N-methylolmethacrylamide and methacrylamide derivatives such as derivatives of N-methylolmethacrylamide; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether; nitriles such as acrylonitrile and methacrylonitrile; halogenated vinyls such as vinyl chloride and vinyl fluoride; halogenated vinylidene such as vinylidene chloride and vinylidene fluoride; allyl compounds such as allyl acetate and allyl chloride; unsaturated dicarboxylic acids such as maleic acid, itaconic acid, and fumaric acid, and salts and esters thereof; vinyl silyl compounds such as vinyl trimethoxysilane; isopropenyl acetate, etc. A content percentage of these monomers varies depending on a usage purpose, an intended usage, and/or the like, and is preferably 10 mol % or less, more preferably less than 5 mol %, still more preferably less than 1 mol %, and particularly preferably less than 0.5 mol %, and may be 0 mol %. The PVA may be contained alone of one type, or two or more types thereof may be contained.

The EVOH is typically a polymer obtained by saponifying an ethylene-vinyl ester copolymer obtained by polymerizing ethylene and a vinyl ester.

An ethylene unit content of the EVOH is preferably 20 to 50 mol %. When the ethylene unit content is 20 mol % or more, melt formability of the EVOH and melt formability of ground matter of a multilayer film or a multilayer structure containing the EVOH may improve. The ethylene unit content is preferably 23 mol % or more, and more preferably 26 mol % or more, and may be 29 mol % or more, 32 mol % or more, 35 mol % or more, or 38 mol % or more. On the other hand, when the ethylene unit content is 50 mol % or less, the gas barrier properties of the multilayer film of the present invention may improve. The ethylene unit content is preferably 46 mol % or less, and more preferably 42 mol % or less, and may be 38 mol % or less, 34 mol % or less, or 30 mol % or less. The ethylene unit content is a content (mol %) of an ethylene unit with respect to total monomer units constituting the EVOH.

Furthermore, a degree of saponification of the EVOH is preferably 90 mol % or more. The degree of saponification of the EVOH means a proportion of the number of vinyl alcohol units with respect to a total number of vinyl alcohol units and vinyl ester units in the EVOH. When the degree of saponification is 90 mol % or more, the gas barrier properties of the multilayer film of the present invention may improve. The degree of saponification is preferably 95 mol % or more, more preferably 99 mol % or more, and still more preferably 99.9 mol % or more. The upper limit of the degree of saponification of the EVOH may be 100 mol %. The ethylene unit content and the degree of saponification of the EVOH are determined by 1H-NMR measurement.

The EVOH may be a mixture of two or more types of EVOHs having different ethylene unit contents. In this case, the difference of the ethylene unit contents of the EVOHs whose difference of the ethylene unit contents is the largest is preferably 30 mol % or less, more preferably 20 mol % or less, and still more preferably 15 mol % or less, and may be 3 mol % or more. Similarly, the EVOH may be a mixture of two or more types of EVOHs having different degrees of saponification. In this case, the difference of the degrees of saponification of the EVOHs whose difference of the degrees of saponification is the largest is preferably 7 mol % or less, and more preferably 5 mol % or less, and may be 0.5 mol % or more. In a case in which it is desired to achieve both thermal formability and gas barrier properties at higher levels, it is preferred to use a mixture of an EVOH (less than 34 mol %) having an ethylene unit content of 24 mol % or more and less than 34 mol % and a degree of saponification of 99 mol % or more, and an EVOH (34 mol % or more) having an ethylene unit content of 34 mol % or more and less than 50 mol % and a degree of saponification of 99 mol % or more in a blending mass ratio (less than 34 mol %/34 mol % or more) of 60/40 to 90/10.

The EVOH may be an EVOH having a melting point of 150° C. or more and less than 190° C., or may be an EVOH having a melting point of less than 150° C. When the melting point of the EVOH is lower than 150° C., appearance and/or interlayer adhesiveness of the multilayer film including the layer (X) as an outermost layer may be improved. The reason for this is considered to be that the melting point of the EVOH being lower than 150° C. leads to an improvement in fluidity of a polymer chain, and thus, a stress can be effectively relaxed even at a relatively low temperature during melt forming and during secondary processing such as stretching, and adhesion reaction activity to an adjacent layer can be maintained. In light of making more remarkable the effects of the present invention, the melting point of the EVOH is preferably lower than 140° C., and more preferably lower than 130° C., and may be lower than 125° C. or lower than 120° C. On the other hand, in light of processability during melt forming and during secondary processing such as stretching, and in light of heat resistance as a packaging material, the melting point of the EVOH is preferably 80° C. or higher, more preferably 90° C. or higher, and still more preferably 100° C. or higher. The melting point of the EVOH is controlled by one of the following items or a combination of a plurality thereof, but in the present invention, the method of (3) described below can be preferably exemplified.
(1) Changing the ethylene unit content (increasing the ethylene unit content lowers the melting point).
(2) Changing the degree of saponification (lowering the degree of saponification lowers the melting point).
(3) Introducing a modifying group containing a primary hydroxy group (introducing a modifying group containing a primary hydroxy group lowers the melting point).

The modifying group containing a primary hydroxy group used in (3) is preferably a modifying group represented by the following general formula (I) and containing a primary hydroxy group. The degree of melting point reduction per introduction rate of the modifying group varies depending on the structure of the modifying group containing a primary hydroxy group to be introduced, but when 1 mol % of the modifying group represented by the following general formula (I) and containing a primary hydroxy group is introduced, the melting point typically lowers by about 6 to 9° C. In a case in which the melting point is controlled by this method, it is possible to lower the melting point while gas barrier properties and/or thermal stability are/is relatively maintained, and also it is possible to inhibit the decrease in interlayer adhesiveness with the layer (Y) and the vapor-deposited inorganic layer (I) described later, and thus enable providing a multilayer film having particularly superior quality and performance. The reason for this is considered to be, for example, that the melting point can be lowered in a state where the amount of hydroxy groups is maintained, and that the primary hydroxy group has high adhesion reaction activity to the layer (Y) and the vapor-deposited inorganic layer (I) described later. A content of the modifying group containing a primary hydroxy group in the EVOH can be appropriately adjusted considering the balance between the melting point and various physical properties, but it is often the case that a content of 2 mol % or more and less than 20 mol % results in a favorable balance of physical properties. The lower limit of the content of the modifying group containing a primary hydroxy group in the EVOH is more preferably 3 mol %. On the other hand, the upper limit of the content of the modifying group containing a primary hydroxy group in the EVOH is more preferably 10 mol %, and still more preferably 8 mol %. The modifying group containing a primary hydroxy group can be introduced by copolymerization or a polymer reaction. The “content of the modifying group containing a primary hydroxy group in the EVOH” as referred to herein may mean a content (mol %) of monomer units containing a primary hydroxy group with respect to total monomer units constituting the EVOH.

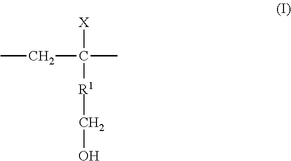

wherein X represents a hydrogen atom, a methyl group, or a group represented by R²—OH; and R¹ and R² each independently represent a single bond, an alkylene group having 1 to 9 carbon atoms, or an alkyleneoxy group having 1 to 9 carbon atoms, wherein the alkylene group and the alkyleneoxy group may contain a hydroxy group, an alkoxy group, or a halogen atom.

In the general formula (I), X represents preferably a hydrogen atom or a group represented by R²—OH, and more preferably a hydrogen atom. R¹ represents preferably a single bond, an alkylene group having 1 to 5 carbon atoms, or an alkyleneoxy group having 1 to 5 carbon atoms, and more preferably a methylmethyleneoxy group (—O—C(CH₃) H)—). In the case in which R¹ represents an alkyleneoxy group, an oxygen atom of the alkyleneoxy group typically bonds to a carbon atom on the main chain.

The EVOH may contain other monomer unit aside from the ethylene unit, the vinyl ester unit, the vinyl alcohol unit, and the modifying group containing a primary hydroxy group, within a range not leading to impairment of the effects of the present disclosure. A content of the other monomer unit is preferably 5% by mass or less, more preferably 3% by mass or less, still more preferably 1% by mass or less, and particularly preferably the other monomer unit is substantially not contained. Examples of the other monomer include: alkenes such as propylene, butylene, pentene, and hexene; alkenes having an ester group such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene, and 1,3-diacetoxy-2-methylenepropane, and saponified products thereof; unsaturated acids such as acrylic acid, methacrylic acid, crotonic acid, and itaconic acid, and anhydrides, salts, mono- or dialkyl esters, and the like thereof, nitriles such as acrylonitrile and methacrylonitrile; amides such as acrylamide and methacrylamide; olefin sulfonic acids such as vinylsulfonic acid, allylsulfonic acid, and methallylsulfonic acid, and salts thereof; vinylsilane compounds such as vinyltrimethoxysilane, vinyltriethoxysilane, vinyltri(β-methoxy-ethoxy) silane, and γ-methacryloxypropylmethoxysilane; alkyl vinyl ethers; vinyl ketone; N-vinylpyrrolidone; vinyl chloride; vinylidene chloride; and the like.

The EVOH may be subjected to post-modification by a process such as urethanization, acetalization, cyanoethylation, oxyalkylenation, or the like.

The MFR (190° C. under a load of 2.160 kg) of the EVOH, as measured in accordance with JIS K7210-1 (2014) is preferably 0.2 to 20 g/10 min. The MFR of the EVOH is more preferably 0.5 g/10 min or more, and still more preferably 0.8 g/10 min or more. On the other hand, the MFR of the EVOH is more preferably 15 g/10 min or less, still more preferably 10 g/10 min or less, yet more preferably 5 g/10 min or less, and particularly preferably 3 g/10 min or less. When the MFR of the EVOH falls within the range, melt formability of the EVOH and ground matter of the multilayer film and the multilayer structure containing the EVOH improves.

A proportion accounted for by the EVOH in the gas barrier resin (a) is preferably 50% by mass or more, more preferably 70% by mass or more, still more preferably 90% by mass or more, and it is particularly preferred that the gas barrier resin (a) is the EVOH.

The gas barrier resin (a) may be used alone of one type, or in combination of two or more types.

The gas barrier resin (a) is preferably a principal component of the layer (X). Due to the gas barrier resin (a) being a principal component of the layer (X), the gas barrier properties and the like of the multilayer film more improve. The lower limit of a content of the gas barrier resin (a) in the layer (X) is preferably 70% by mass, more preferably 80% by mass, still more preferably 90% by mass, yet more preferably 95% by mass, and particularly preferably 97% by mass. The upper limit of the content of the gas barrier resin (a) in the layer (X) is preferably 99.8% by mass, more preferably 99.5% by mass, and still more preferably 99.0% by mass.

### Polyolefin (b)

The resin composition (A) of the present invention contains the polyolefin (b) having a melt flow rate (MFR) of 3.0 g/10 min or more in accordance with JIS K7210-1 (2014; 190° C., load of 2.160 kg). When the MFR is less than 3.0 g/10 min, the die buildup cannot be sufficiently inhibited during multilayer film production. The MFR of the polyolefin (b) is preferably 5 g/10 min or more, more preferably 10 g/10 min or more, still more preferably 50 g/10 min or more, and particularly preferably 100 g/10 min or more, and may be 130 g/10 min or more, 170 g/10 min or more, or 180 g/10 min or more. In a case of the MFR being more than 1,000 g/10 min, accuracy of the MFR decreases for the convenience of the measurement. Thus, herein, in a case of the MFR being more than 1,000 g/10 min, the melt viscosity is defined by another measurement method (BL viscometer (Brookfield viscometer)). In a case in which the MFR of the polyolefin (b) is 1,000 g/10 min or less, the MFR of the polyolefin (b) may be 1,000 g/10 min or less, 500 g/10 min or less, or 300 g/10 min or less.

In a case in which the MFR of the polyolefin (b) is more than 1,000 g/10 min, a melt viscosity of the polyolefin (b) measured at 140° C. with a BL viscometer is preferably 300 to 10,000 mPa·s, more preferably 1,500 to 8,000 mPa·s, and still more preferably 3,000 to 6,000 mPa·s.

The polyolefin (b) may be a polymer having a content (mol %) of an olefin unit of more than 50 mol % with respect to total monomer units. The lower limit of the content of the olefin unit with respect to the total monomer units in the polyolefin (b) is preferably 60 mol %, more preferably 70 mol %, still more preferably 75 mol %, and yet more preferably 80 mol %, and may be 85 mol %, 90 mol %, or 92 mol %. The upper limit of the content of the olefin unit with respect to the total monomer units in the polyolefin (b) may be 100 mol %, or may be 99 mol %, 98 mol %, 97 mol %, or 96 mol %.

The polyolefin (b) is exemplified by polyethylenes, polypropylenes, poly(1-butene), poly(4-methyl-1-pentene), copolymers of polyolefin and maleic anhydride, EVAs and saponified products thereof, ethylene-acrylic acid ester copolymers, modified polyolefins obtained by graft-modifying these with an unsaturated carboxylic acid or a derivative thereof, etc. Of these, in light of exhibiting an effect of inhibiting the die buildup, the polyolefin (b) is preferably at least one selected from the group consisting of a polyethylene, a polypropylene, an EVA, and a saponified product of an EVA, more preferably at least one selected from the group consisting of a polyethylene, an EVA, and a saponified product of an EVA, and still more preferably at least one selected from the group consisting of a polyethylene and a saponified product of an EVA, and in light of recyclability, particularly preferably a saponified product of an EVA.

In the case in which the polyolefin (b) is an EVA or a saponified product thereof, the ethylene unit content is preferably 75 mol % or more and 98 mol % or less in light of exhibiting the effect of inhibiting the die buildup. When the ethylene unit content falls within the range, generation of the die buildup during multilayer film production tends to be able to be more inhibited. An ethylene unit content of the EVA or the saponified product thereof is more preferably 85 mol % or more and 96 mol % or less. The ethylene unit content of the EVA or the saponified product thereof is determined by 1H-NMR measurement.

In the case in which the polyolefin (b) is a saponified product of an EVA, the degree of saponification is preferably 30 mol % or more, more preferably 50 mol % or more, still more preferably 70 mol % or more, and particularly preferably 85 mol % or more, in light of exhibiting the effect of inhibiting the die buildup. On the other hand, the degree of saponification is preferably 99 mol % or less. The degree of saponification of the saponified product of an EVA is determined by 1H-NMR measurement.

The number-average molecular weight (hereinafter, may be abbreviated to Mn) of the polyolefin (b) is preferably 3,000 to 25,000 in light of exhibiting the effect of inhibiting the die buildup. The Mn of the polyolefin (b) is more preferably 5,000 to 22,500, and still more preferably 10,000 to 20,000. The Mn of the polyolefin (b) is determined by GPC (gel permeation chromatographic) measurement.

In the case in which the polyolefin (b) is polyethylene, the MFR of the polyolefin (b) is preferably more than 1,000 g/10 min. In other words, in the case in which the polyolefin (b) is polyethylene, a melt viscosity of the polyolefin (b) measured at 140° C. with a BL viscometer is preferably 300 to 10,000 mPa·s, more preferably 1,500 to 8,000 mPa·s, and still more preferably 3,000 to 6,000 mPa·s. In the case in which the polyolefin (b) is a saponified product of an EVA, the MFR of the polyolefin (b) is more preferably 10 g/10 min or more, still more preferably 50 g/10 min or more, and particularly preferably 100 g/10 min or more, and may be 150 g/10 min or more. Furthermore, in the case in which the polyolefin (b) is a saponified product of an EVA, the MFR of the polyolefin (b) is preferably 500 g/10 min or less, more preferably 400 g/10 min or less, still more preferably 300 g/10 min or less, and particularly preferably 250 g/10 min or less.

The resin composition (A) contains 0.1 parts by mass or more and 20 parts by mass or less of the polyolefin (b) with respect to 100 parts by mass of the gas barrier resin (a). A content of the polyolefin (b) is preferably 12 parts by mass or less, more preferably 8 parts by mass or less, and still more preferably 5 parts by mass or less, and may be 4 parts by mass or less or 3 parts by mass or less. When the content of the polyolefin (b) is less than or equal to the upper limit, the gas barrier properties and the recyclability tend to be favorable. Furthermore, the content of the polyolefin (b) is preferably 0.5 parts by mass or more, and more preferably 1.0 part by mass or more. When the content of the polyolefin (b) is more than or equal to the lower limit, the die buildup tends to be able to be more inhibited.

### Alkali Metal Ion (c)

The resin composition (A) preferably contains an alkali metal ion (c) at a concentration of 40 to 500 ppm. Due to the resin composition (A) containing the alkali metal ion (c) within the range, the interlayer adhesiveness with a layer (Y) described later tends to improve remarkably. When the alkali metal ion (c) is at a concentration of 40 ppm or more, recyclability tends to improve. On the other hand, when a content of the alkali metal ion (b) is 500 ppm or less, the recyclability and/or hue of the recovered composition tend(s) to be favorable. The lower limit of the content of the alkali metal ion (c) is more preferably 80 ppm, and still more preferably 120 ppm. The upper limit of the content of the alkali metal ion (c) is preferably 400 ppm, and more preferably 300 ppm. Furthermore, by controlling a content proportion of the alkali metal ion (c) and carboxylic acid described later, the melt formability and/or coloring resistance of the resin composition (A) to be obtained can be further improved.

Examples of the alkali metal ion (c) include ions of lithium, sodium, potassium, rubidium, cesium, and the like; in light of industrial availability, an ion of sodium or potassium is preferred. These can be used alone of one type, or in combination of two or more types.

Examples of an alkali metal compound which gives the alkali metal ion (c) include aliphatic carboxylic acid salts, aromatic carboxylic acid salts, carbonates, hydrochloric acid salts, nitric acid salts, sulfuric acid salts, phosphoric acid salts, hydroxides, metal complexes, and the like of an alkali metal, such as lithium, sodium, potassium, or the like. Of these, in light of availability and easiness of handling, the aliphatic carboxylic acid salts and the phosphoric acid salts are preferred. The aliphatic carboxylic acid salts are preferably acetic acid salts, caprylic acid salts, and stearic acid salts.

### Multivalent Metal Ion (d)

The resin composition (A) preferably contains at least one type of multivalent metal ion (d) selected from the group consisting of a magnesium ion, a calcium ion, and a zinc ion, at a concentration of 20 ppm or more and 2,000 ppm or less. When the multivalent metal ion (d) is contained at a concentration of 20 ppm or more, thickening, gelation, and/or adhesion of the resin to a screw tend(s) to be inhibited, and also generation of the die buildup during multilayer film production tends to be able to be more inhibited. The lower limit of the multivalent metal ion (d) is more preferably 40 ppm, still more preferably 100 ppm, and particularly preferably 150 ppm. On the other hand, when a content of the multivalent metal ion (d) is 2,000 ppm or less, excessive decomposition and/or coloring of the resin composition (A) during melt forming tend(s) to be able to be inhibited, and also interlayer adhesiveness between the layer (X) and the layer (Y) can be maintained. The upper limit of the multivalent metal ion (d) is preferably 1,500 ppm, more preferably 1,000 ppm, and particularly preferably 500 ppm, and may be 300 ppm. As the multivalent metal ion (d), the resin composition (A) preferably contains a magnesium ion or a calcium ion, and more preferably contains a calcium ion in light of easiness of maintaining quality of the resin composition (A) and in light of coloring of the recovered composition. Furthermore, by controlling a content proportion of the multivalent metal ion (d) and carboxylic acid described later, melt formability and/or coloring resistance of the resin composition (A) to be obtained can be further improved.

Examples of a multivalent metal compound which gives the multivalent metal ion (d) include aliphatic carboxylic acid salts, aromatic carboxylic acid salts, carbonates, hydrochloric acid salts, nitric acid salts, sulfuric acid salts, phosphoric acid salts, hydroxides, metal complexes, and the like of magnesium, calcium, and zinc. Of these, in light of availability and easiness of handling, the aliphatic carboxylic acid salts and the hydroxides are preferred. The aliphatic carboxylic acid salts are preferably acetic acid salts, caprylic acid salts, and stearic acid salts.

### Higher Aliphatic Carboxylic Acid (e)

The resin composition (A) preferably contains a higher aliphatic carboxylic acid (e) having 8 to 30 carbon atoms, at a concentration of 100 to 25,000 ppm. A part or all of the higher aliphatic carboxylic acid (e) can be contained as a salt, or can be contained as a salt of the alkali metal ion (c) or the multivalent metal ion (d). The higher aliphatic carboxylic acid (e) is preferably caprylic acid or stearic acid. The multilayer film of the present invention includes as an outermost layer, the layer (X) consisting of the resin composition (A), and it is considered that in a die, the higher aliphatic carboxylic acid (e) serves as a lubricant to a metal surface of the die, whereby defective appearance due to thickness unevenness of the multilayer film and/or generation of gels and/or aggregates due to a residual resin can be inhibited. Thus, the resin composition (A) preferably contains the higher aliphatic carboxylic acid (e) at a concentration of 100 ppm or more. On the other hand, when a content of the higher aliphatic carboxylic acid (e) is 25,000 ppm or less, thickening of the resin composition (A) during melt forming tends to be able to be inhibited, and interlayer adhesiveness to the layer (Y) described later tends to be able to be maintained. In light of these, the content of the higher aliphatic carboxylic acid (e) is more preferably 200 to 20,000 ppm, and still more preferably 300 to 15,000 ppm.

The resin composition (A) may contain, within a range not leading to impairment of the effects of the present invention, other component aside from the gas barrier resin (a), the polyolefin (b), the alkali metal ion (c), the multivalent metal ion (d), and the higher aliphatic carboxylic acid (e). Examples of the other component include alkaline earth metal ions and transition metal ions other than the multivalent metal ion (d), a carboxylic acid (a monocarboxylic acid, a multivalent carboxylic acid) other than the higher aliphatic carboxylic acid (e), a thermoplastic resin other than the gas barrier resin (a) and the polyolefin (b), a phosphoric acid compound, a boron compound, a pro-oxidant, an antioxidant (a hindered phenol compound and the like), a plasticizer, a thermal stabilizer (a melt stabilizer), a photo initiator, a deodorant, an ultraviolet ray-absorbing agent, an antistatic agent, a lubricant, a colorant, a filler, a desiccant, a filler, a pigment, a dye, a processing aid, a flame retardant, an antifogging agent, a surfactant, a crosslinking agent, a fiber-reinforcing agent, and the like. The carboxylic acid and/or the phosphoric acid compound are/is preferably contained in light of being able to inhibit coloring during melt forming of ground matter of the multilayer film or the multilayer structure containing the resin composition (A). Furthermore, containing the boron compound enables controlling a melt viscosity of the resin composition (A) and ground matter of the multilayer film or the multilayer structure containing the resin composition (A).

### Carboxylic Acid

The resin composition (A) preferably contains a carboxylic acid other than the higher aliphatic carboxylic acid (e). The lower limit of a content of the carboxylic acid is preferably 50 ppm, and more preferably 100 ppm. On the other hand, the upper limit of the content of the carboxylic acid is preferably 400 ppm, and more preferably 350 ppm. In a case in which the content of the carboxylic acid is 50 ppm or more, coloring resistance tends to be favorable. On the other hand, in a case in which the content of the carboxylic acid is 400 ppm or less, interlayer adhesiveness tends to be able to be maintained and generation of smell tends to be able to be inhibited.

pKa of the carboxylic acid is preferably 3.5 to 5.5. When the pKa of the carboxylic acid falls within the range, pH buffering capacity of the resin composition (A) to be obtained can increase, melt formability can be further improved, and coloring due to acid substances and/or basic substances can be further improved.

The carboxylic acid may be a monovalent carboxylic acid. These can be used alone of one type or in combination of two or more types. The monovalent carboxylic acid as referred to herein means a compound having one carboxyl group inside the molecule. The monovalent carboxylic acid having a pKa falling within the range of 3.5 to 5.5 is not particularly limited, and is exemplified by formic acid (pKa=3.77), acetic acid (pKa=4.76), propionic acid (pKa=4.85), acrylic acid (pKa=4.25), and the like. These carboxylic acids may further have a substituent such as a hydroxy group, an amino group, or a halogen atom. Of these, in light of being superior in safety and being available and easy to handle, acetic acid is preferred.

The carboxylic acid may be a multivalent carboxylic acid. When the carboxylic acid is a multivalent carboxylic acid, coloring resistance of the resin composition (A) at high temperatures and/or coloring resistance of a melt formed product of ground matter of a multilayer structure to be obtained may be further improved. Furthermore, the multivalent carboxylic acid compound preferably has three or more carboxyl groups. In this case, the coloring resistance may be able to be more effectively improved. The multivalent carboxylic acid as referred to herein means a compound having two or more carboxyl groups inside the molecule. In this case, the pKa of at least one carboxyl group preferably falls within the range of 3.5 to 5.5, and examples of the multivalent carboxylic acid include oxalic acid (pKa2 of 4.27), succinic acid (pKa1 of 4.20), fumaric acid (pKa2 of 4.44), malic acid (pKa2 of 5.13), glutaric acid (pKa1 of 4.30, pKa2 of 5.40), adipic acid (pKa1 of 4.43, pKa2 of 5.41), pimelic acid (pKa 1 of 4.71), phthalic acid (pKa2 of 5.41), isophthalic acid (pKa2 of 4.46), terephthalic acid (pKa1 of 3.51, pKa2 of 4.82), citric acid (pKa2 of 4.75), tartaric acid (pKa2 of 4.40), glutamic acid (pKa 2 of 4.07), aspartic acid (pKa of 3.90), and the like.

### Phosphoric Acid Compound

The resin composition (A) may further contain a phosphoric acid compound. The lower limit of a content of the phosphoric acid compound is preferably 5 ppm in terms of phosphate radical equivalent. On the other hand, the upper limit of the content of the phosphoric acid compound is preferably 100 ppm in terms of phosphate radical equivalent. When the phosphoric acid compound is contained within the range, coloring of the resin composition (A) to be obtained and a melt formed product of ground matter of the multilayer film or the multilayer structure to be obtained may be inhibited, and thermal stability may be improved.

As the phosphoric acid compound, for example, various acids, such as phosphoric acid and phosphorous acid, salts thereof, and the like may be used. The phosphoric acid salts may be any of phosphate monobasic, phosphate dibasic, and phosphate tribasic. Cation species of the phosphoric acid salts are not particularly limited, and the cation species are preferably alkali metals and alkaline earth metals. Of these, sodium dihydrogen phosphate, potassium dihydrogen phosphate, disodium hydrogen phosphate, and dipotassium hydrogen phosphate are preferred as the phosphoric acid compound.

### Boron Compound

The resin composition (A) may further contain a boron compound. In a case of containing a boron compound, the lower limit of the content in the resin composition (A) is preferably 50 ppm, and more preferably 100 ppm in terms of boron element equivalent. On the other hand, the upper limit of the content of the boron compound in the resin composition (A) is preferably 400 ppm, and more preferably 200 ppm in terms of boron element equivalent. Due to containing the boron compound within this range, the thermal stability during melt forming of the resin composition (A) and ground matter of the multilayer film or the multilayer structure to be obtained may improve, and generation of gels and aggregates may be inhibited. Furthermore, drawdown resistance and/or neck-in resistance during film formation may improve, and/or mechanical properties of a formed product to be obtained may improve. It is presumed that these effects are due to chelate interaction occurring between the gas barrier resin (a) such as an EVOH and the boron compound.

The boron compound is exemplified by boric acids, boric acid esters, boric acid salts, and boron hydrides. Specifically, examples of the boron compound include: boric acids such as orthoboric acid (H₃BO₃), metaboric acid, and tetraboric acid; boric acid esters such as trimethyl borate and triethyl borate; boric acid salts such as alkali metal salts and alkaline earth metal salts of the above boric acids, and borax; and the like. Of these, orthoboric acid is preferred.

### Hindered Phenol Compound

The resin composition (A) may further contain a hindered phenol compound as an antioxidant. In a case in which the hindered phenol compound is contained, a content of the hindered phenol compound in the resin composition (A) is preferably 1,000 to 10,000 ppm. When the content is 1,000 ppm or more, coloring, thickening, and gelation of the resin during melt forming of ground matter of the multilayer film or the multilayer structure can be inhibited. The content of the hindered phenol compound is more preferably 2,000 ppm or more. On the other hand, when the content of the hindered phenol compound is 10,000 ppm or less, coloring and/or bleeding out derived from the hindered phenol compound can be inhibited. The content of the hindered phenol compound is more preferably 8,000 ppm or less.

The hindered phenol compound has at least one hindered phenol group. The hindered phenol group as referred to herein means a group in which a bulky substituent bonds to at least one of the carbons adjacent to the carbon to which the hydroxyl group of the phenol bonds. The bulky substituent is preferably an alkyl group having 1 to 10 carbon atoms, and more preferably a t-butyl group.

The hindered phenol compound is preferably in a solid state around room temperature. In light of inhibiting bleeding out of the hindered phenol compound, a melting point or a softening temperature of the hindered phenol compound is preferably 50° C. or higher, more preferably 60° C. or higher, and still more preferably 70° C. or higher. In light of similar matter, a molecular weight of the hindered phenol compound is preferably 200 or more, more preferably 400 or more, and still more preferably 600 or more. On the other hand, the molecular weight is typically 2,000 or less. Furthermore, in light of facilitating mixing with the gas barrier resin (a) such as an EVOH, the melting point or the softening temperature of the hindered phenol compound is preferably 200° C. or lower, more preferably 190° C. or lower, and still more preferably 180° C. or lower.

The hindered phenol compound preferably has an ester bond or an amide bond. Examples of the hindered phenol compound having an ester bond include an ester of an aliphatic carboxylic acid having a hindered phenol group with an aliphatic alcohol, and examples of the hindered phenol compound having an amide bond include an amide of an aliphatic carboxylic acid having a hindered phenol group with an aliphatic amine. Of these, the hindered phenol compound preferably has an amide bond.

Specific structures of the hindered phenol compound having an ester bond or an amide bond include pentaerythritol tetrakis[3-(3,5-di-tert-butyl-4-hydroxyphenyl) propionate], which is commercially available from BASF as Irganox 1010; stearyl 3-(3,5-di-tert-butyl-4-hydroxyphenyl) propionate, which is commercially available as Irganox 1076; 2,2′-thiodiethyl bis[3-(3,5-di-tert-butyl-4-hydroxyphenyl) propionate], which is commercially available as Irganox 1035; octadecyl 3-(3,5-di-tert-butyl-4-hydroxyphenyl) propanoate, which is commercially available as Irganox 1135; bis(3-tert-butyl-4-hydroxy-5-methylbenzene-propanoic acid) ethylene bis(oxyethylene), which is commercially available as Irganox 245; 1,6-hexanediol bis[3-(3,5-di-tert-butyl-4-hydroxyphenyl) propionate], which is commercially available as Irganox 259; and N,N′-hexamethylene bis[3-(3,5-di-tert-butyl-4-hydroxyphenyl) propanamide], which is commercially available as Irganox 1098. Of these, N,N′-hexamethylene bis[3-(3,5-di-tert-butyl-4-hydroxyphenyl) propanamide], which is commercially available as Irganox 1098, and pentaerythritol tetrakis[3-(3,5-di-tert-butyl-4-hydroxyphenyl) propionate], which is commercially available as Irganox 1010, are preferred, and the former is more preferred.

The resin composition (A) may further contain a thermoplastic resin other than the gas barrier resin (a) and the polyolefin (b). The thermoplastic resin other than the gas barrier resin (a) and the polyolefin (b) is exemplified by polyolefins having an MFR of less than 3.0 g/10 min at 190° C. under a load of 2.160 kg, as measured in accordance with JIS K7210-1 (2014), various polyesters (such as polyethylene terephthalate, polybutylene terephthalate, polyethylene naphthalate), polyvinyl chloride, polyvinylidene chloride, polystyrenes, polyacrylonitriles, polyurethanes, polycarbonate, polyacetals, polyacrylates, and the like. A content of the thermoplastic resin in the resin composition (A) is typically less than 40% by mass, preferably less than 30% by mass, more preferably less than 20% by mass, and still more preferably less than 10% by mass, may be less than 5% by mass, or may be less than 1% by mass, and particularly preferably, the thermoplastic resin is not substantially contained.

In light of inhibiting the die buildup, a proportion accounted for by a total mass of the gas barrier resin (a) and the polyolefin (b) in resins constituting the resin composition (A) is preferably 60% by mass or more, more preferably 70% by mass or more, still more preferably 80% by mass, yet more preferably 90% by mass or more, and particularly preferably 95% by mass or more. The resins constituting the resin composition (A) may be substantially only the gas barrier resin (a) and the polyolefin (b), and the resins constituting the resin composition (A) may consist only of the gas barrier resin (a) and the polyolefin (b). Furthermore, in light of inhibiting the die buildup, the proportion accounted for by the total mass of the gas barrier resin (a) and the polyolefin (b) in the resin composition (A) is preferably 60% by mass or more, more preferably 70% by mass or more, still more preferably 80% by mass, yet more preferably 90% by mass or more, and particularly preferably 95% by mass or more, and may be 98% by mass or more or may be 99% by mass or more.

It is preferred that in thermogravimetry (TG), a weight loss W of the resin composition (A) after being maintained at 200° C. for 30 minutes in a nitrogen atmosphere is 0.01 to 0.3%. The weight loss W reflects low molecular weight components inherent in the resin composition (A), and/or decomposition characteristics of the gas barrier resin (a) and the polyolefin (b) due to heat. Due to the layer (X) consisting of the resin composition (A) satisfying the specific TG conditions, it is possible to stably produce the multilayer film having superior appearance characteristics over a long time period. In light of enabling stably producing a multilayer film having more superior appearance characteristics, the weight loss W after being maintained at 200° C. for 30 minutes in a nitrogen atmosphere is preferably 0.02 to 0.15%, more preferably 0.03 to 0.10%, and still more preferably 0.04 to 0.08%. W can be controlled by: the ethylene unit content and the degree of saponification in a case of the gas barrier resin (a) being an EVOH; the types and the contents of the polyolefin (b), the alkali metal ion (c), the multivalent metal ion (d), the higher aliphatic carboxylic acid (e), and other component contained in the resin composition (A); and the production conditions (especially, thermal history such as temperature and time period) during production of the resin composition (A). For example, when the resin composition (A) is produced by melt kneading, the weight loss W tends to be made smaller by performing the melt kneading while gas components were removed using a venting device or the like.

A method for producing the resin composition (A) is not particularly limited, and the resin composition (A) can be produced by melt kneading the gas barrier resin (a) and the polyolefin (b), as well as other components such as the alkali metal ion (c), the multivalent metal ion (d), and the higher aliphatic carboxylic acid (e) as needed. Each component may be blended in a solid state such as powder or as a molten material, or may be blended as a solute contained in a solution or a dispersoid contained in a dispersion. As the solution and the dispersion, an aqueous solution and an aqueous dispersion are suitable, respectively. For the melt kneading, a mixing device or a kneading device that is known such as a kneader ruder, an extruder, a mixing roll, or a Banbury mixer can be used, for example. A temperature range during the melt kneading can be appropriately adjusted depending on, e.g., melting points of the gas barrier resin (a) and/or each component to be used; 150 to 250° C. are typically used. Alternatively, the gas barrier resin (a) may be produced by preliminarily adding some components to the gas barrier resin (a), and then melt kneading additionally-required other component(s) as described above. A method for preliminarily adding some components to the gas barrier resin (a) is exemplified by a method for immersing the gas barrier resin (a) as pellets or powder into a solution in which added components have been dissolved. The solution is suitably an aqueous solution. Of these, in light of inhibiting the die buildup, it is preferred to melt knead the gas barrier resin (a) and the polyolefin (b) to obtain pellets of the resin composition (A). Furthermore, the layer (X) is preferably a layer melt formed from pellets consisting only of the resin composition (A).

### Layer (Y)

The multilayer film of the present invention includes at least one layer different from the layer (X). In particular, the multilayer film of the present invention preferably includes the layer (Y) containing an adhesive resin (B) having a melting point of less than 170° C. as a principal component. Due to the multilayer film of the present invention including the layer (Y), the multilayer film superior in appearance and interlayer adhesiveness tends to be obtained. Furthermore, due to including the layer (Y), the compatibility between the layer (X) and the layer (Z), which will be described later, tends to improve during recycling, and thus, recyclability tends to improve. The adhesive resin (B) is exemplified by, e.g., an acid-modified polyolefin resin prepared by graft-polymerizing a polyolefin resin with an unsaturated carboxylic acid such as maleic anhydride or a derivative thereof. A melting point of the adhesive resin (B) mainly depends on the polyolefin resin before the acid modification. The contents described about unmodified ones of the polyolefin resin (C) described later can directly apply to the polyolefin resin, but it is preferred that the adhesive resin (B) is an acid-modified polyethylene or an acid-modified polypropylene. The acid-modified polyolefin resin may be a carboxylic acid-modified polyolefin resin. Furthermore, the acid-modified polyethylene may be a carboxylic acid-modified polyethylene, and the acid-modified polypropylene may be a carboxylic acid-modified polypropylene.

A proportion accounted for by the acid-modified polyolefin resin in the adhesive resin (B) is preferably 70% by mass or more, more preferably 80% by mass or more, and still more preferably 95% by mass or more, and the adhesive resin (B) may be constituted from substantially only the acid-modified polyolefin resin, or may be constituted from only the acid-modified polyolefin resin. Furthermore, a proportion accounted for by the adhesive resin (B) in the layer (Y) is preferably 70% by mass or more, more preferably 80% by mass or more, and still more preferably 95% by mass or more, and the layer (Y) may be constituted from substantially only the adhesive resin (B), or may be constituted from only the adhesive resin (B).

### Layer (Z)

The multilayer film of the present invention preferably includes a layer (Z) containing as a principal component, a polyolefin resin (C) having a melting point of less than 170° C. The polyolefin resin (C) is not particularly limited as long as the polyolefin resin (C) is a polyolefin having a melting point of less than 170° C.; the polyolefin resin (C) is exemplified by: polyethylene resins such as a linear low-density polyethylene, a low-density polyethylene, a medium-density polyethylene, and a high-density polyethylene; polypropylene resins such as homopolypropylene, random polypropylene, and block polypropylene; vinyl ester resins; ethylene-propylene copolymers; propylene-α-olefin copolymers (α-olefins having 4 to 20 carbon atoms); homopolymers of an olefin such as polybutene or polypentene and copolymers thereof; chlorinated polyethylenes; and the like.

The lower limit of a content of an olefin unit with respect to total monomer units in the polyolefin resin (C) is preferably 60 mol %, more preferably 70 mol %, still more preferably 80 mol %, yet more preferably 90 mol %, and may be 95 mol %, 98 mol %, 99 mol %, or 99.9 mol %. The upper limit of the content of an olefin unit with respect to total monomer units in the polyolefin resin (C) may be 100 mol %. The polyolefin resin (C) may be modified by, e.g., acid modification, or may be unmodified, but it is preferably unmodified.

In light of improving recyclability of the multilayer structure containing the polyolefin resin (C), the polyolefin resin (C) preferably contains a polyethylene resin or a polypropylene resin as a principal component, and more preferably is polyethylene or polypropylene, and still more preferably is polyethylene. Since polyethylene resins or polypropylene resins have been widely used for packaging materials whether they have gas barrier properties or not, recycling infrastructures therefor are widely prepared in each country. In a case in which the polyolefin resin (C) contains polyethylene as a principal component, the polyethylene is preferably at least one selected from the group consisting of a linear low-density polyethylene, a low-density polyethylene, a medium-density polyethylene, and a high-density polyethylene, and more preferably at least one selected from the group consisting of a linear low-density polyethylene and a low-density polyethylene, or a mixture of a high-density polyethylene and at least one selected from the group consisting of a linear low-density polyethylene and a low-density polyethylene.

In light of making the effects of the present invention more remarkable, a melting point of the polyolefin resin (C) is preferably lower than 160° C., and more preferably lower than 150° C., and may be lower than 140° C. or 130° C. On the other hand, in light of processability during melt forming and during secondary processing such as stretching, and in light of heat resistance as a packaging material, the melting point of the polyolefin resin (C) is preferably 80° C. or higher, and more preferably 90° C. or higher. Furthermore, in light of improving melt formability, a melt flow rate (MFR) (190° C. under a load of 2.160 kg) of the polyolefin resin (C), as measured in accordance with a method described in JIS K7210-1 (2014) is preferably 0.1 to 30 g/10 min, more preferably 0.3 to 25 g/10 min, and still more preferably 0.5 to 20 g/10 min.

In a case in which the polyolefin resin (C) contains a polyethylene resin or a polypropylene resin as a principal component, a content of the polyethylene resin or the polypropylene resin in the polyolefin resin (C) is more preferably 70% by mass or more, still more preferably 80% by mass or more, and particularly preferably 95% by mass or more, and the polyolefin resin (C) may be constituted from substantially only the polyethylene resin or the polypropylene resin, or the polyolefin resin (C) may be constituted from only the polyethylene resin or the polypropylene resin. Furthermore, a proportion accounted for by the polyolefin resin (C) in the layer (Z) is preferably 70% by mass or more, more preferably 80% by mass or more, and still more preferably 95% by mass or more, and the layer (Z) may be constituted from substantially only the polyolefin resin (C), or may be constituted from only the polyolefin resin (C).

The layer (Y) contains the adhesive resin (B) as a principal component and the layer (Z) contains the polyolefin resin (C) as a principal component, and these layers may contain, within a range not leading to impairment of the effects of the present invention, other components such as an antioxidant, a plasticizer, a thermal stabilizer (a melt stabilizer), a photo initiator, a deodorant, an ultraviolet ray-absorbing agent, an antistatic agent, a lubricant, a colorant, a filler, a desiccant, a filler, a pigment, a dye, a processing aid, a flame retardant, an antifogging agent, and the like. However, the total amount thereof with respect to each layer is less than 50% by mass, preferably less than 40% by mass, more preferably less than 30% by mass, still more preferably less than 20% by mass, and particularly preferably less than 10% by mass, and may be less than 5% by mass, less than 3% by mass, or less than 1% by mass.

### Multilayer Film

The multilayer film of the present invention includes the layer (X) as an outermost layer, and at least one layer different from the layer (X). The layer different from the layer (X) is not particularly limited, and is preferably at least one selected from the group consisting of the layer (Y) and the layer (Z). It is more preferred that the multilayer film includes the layer (X), the layer (Y), and the layer (Z), and has a structure in which the layer (X), the layer (Y), and the layer (Z) are adjacently laminated in this order. The multilayer film may include a plurality of each of the layer (X), the layer (Y), and the layer (Z). In a case in which a plurality of the layers (X) are present, it is sufficient if at least one of the layers (X) located as the outermost layer is present. In other words, in a case in which a plurality of the layers (X) are present, some of the layers (X) not located as the outermost layer may be present.

The multilayer film of the present invention may include a layer other than the layer (X), the layer (Y), and the layer (Z). However, as one embodiment of the present invention, the multilayer film of the present invention may not include a layer other than the layer (X), the layer (Y), and the layer (Z).

A layer configuration of the multilayer film of the present invention is exemplified by X/Y/Z, X/Y/Z/Y/X, X/Y/Z/Y/X/Y/Z, X/Y/Z/Y/X/Y/Z/Y/X, and the like, where the layer (X), the layer (Y), and the layer (Z) are represented as X, Y, and Z, respectively, and “/” indicates direct lamination.

In light of gas barrier properties, recyclability, and economic efficiency, an average thickness of the layer (X) included in the multilayer film is preferably 0.2 μm or more and less than 20 μm. Furthermore, a proportion of the average thickness of the layer (X) with respect to an average thickness of the multilayer film is also preferably less than 25%. The average thickness of the layer (X) is more preferably 0.4 μm or more and less than 16 μm, and still more preferably 0.6 μm or more and less than 12 μm. The proportion of the average thickness of the layer (X) with respect to the average thickness of the multilayer film is more preferably less than 20%, and still more preferably less than 15%. The proportion of the average thickness of the layer (X) with respect to the average thickness of the multilayer film may be 1% or more. In a case in which a plurality of the layers (X) are present, the above average thickness of the layer (X) is a total of average thicknesses of each layer (X). The average thickness of the multilayer film is equal to a total of average thicknesses of each layer of the multilayer film.

In light of interlayer adhesiveness, recyclability, and economic efficiency, an average thickness of the layer (Y) included in the multilayer film is preferably 0.2 μm or more and less than 20 μm. Furthermore, a proportion of the average thickness of the layer (Y) with respect to the average thickness of the multilayer film is also preferably less than 25%. The average thickness of the layer (Y) is more preferably 0.4 μm or more and less than 16 μm, and still more preferably 0.6 μm or more and less than 12 μm. The proportion of the average thickness of the layer (Y) with respect to the average thickness of the multilayer film is more preferably less than 20%, and still more preferably less than 15%. The proportion of the average thickness of the layer (Y) with respect to the average thickness of the multilayer film may be 1% or more. In a case in which a plurality of the layers (Y) are present, the above average thickness of the layer (Y) is a total of average thicknesses of each layer (Y).

In light of recyclability, an average thickness of the layer (Z) included in the multilayer film is preferably 1 μm or more and less than 200 μm. Furthermore, a proportion of the average thickness of the layer (Z) with respect to the average thickness of the multilayer film is also preferably more than 55%. The average thickness of the layer (Z) is more preferably 5 μm or more, and still more preferably 10 μm or more, and may be 20 μm or more. Furthermore, the average thickness of the layer (Z) is more preferably 100 μm or less, and may be 50 μm or less. The proportion of the average thickness of the layer (Z) with respect to the average thickness of the multilayer film is more preferably more than 60%, and still more preferably more than 70%. The proportion of the average thickness of the layer (Z) with respect to the average thickness of the multilayer film may be 98% or less. In a case in which a plurality of the layers (Z) are present, the above average thickness of the layer (Z) is a total of average thicknesses of each layer (Y).

The average thickness of the multilayer film is preferably 10 μm or more and less than 200 μm, and more preferably 10 μm or more and less than 150 μm. In a case of a stretched multilayer film described later, an average thickness of the stretched multilayer film is preferably 10 μm or more and less than 50 μm, and more preferably 10 μm or more and less than 40 μm.

The multilayer film may be an unstretched multilayer film, but may be a stretched multilayer film that is uniaxially or biaxially (at least uniaxially) stretched. The unstretched multilayer film means a multilayer film that has not been stretched, but some orientation during film formation (for example, orientation applied as if stretching by 1.01 times is applied, or the like) is considered as not being stretched. Furthermore, regarding a uniaxially stretched multilayer film that has been only uniaxially stretched, some orientation in another axial direction during film formation (for example, orientation applied as if stretching by 1.01 times is applied, or the like) is neglected, and only the uniaxial stretch is considered. In the case of the unstretched multilayer film, it may be superior in impact resistance and can also be suitably used as a thermal adhesion film. On the other hand, due to being uniaxially or biaxially stretched, mechanical properties and/or gas barrier properties of a multilayer film to be obtained can be improved. In light of economic efficiency and in light of ease of tearing apart the multilayer film (when the multilayer film is used as a packaging material, the packaging material is easy to be opened), the multilayer film is preferably a uniaxially stretched multilayer film, and in light of obtaining a strong film with little anisotropy in mechanical properties, the multilayer film is preferably a biaxially stretched multilayer film. In light of uniformity of the thickness and mechanical strength of a multilayer film to be obtained, it is preferred that the multilayer film is at least uniaxially stretched by 3 times or more and less than 12 times. In the case of the uniaxially stretched multilayer film, the multilayer film is preferably uniaxially stretched by 3 times or more and less than 12 times, and more preferably uniaxially stretched by 4 times or more and less than 10 times. Furthermore, in the case of the uniaxially stretched multilayer film, the stretching axis is preferably in a machine direction (MD) or in a direction perpendicular to the machine direction, i.e., in the transverse direction (TD), and more preferably in the machine direction (MD). In the case of the biaxially stretched multilayer film, the multilayer film is preferably biaxially stretched each by 3 times or more and less than 12 times, and more preferably each by 4 times or more and less than 10 times.

The lower limit of a proportion, in the multilayer film of the present invention, of a total average thickness of layers each containing a polyethylene resin or a polypropylene resin as a principal component (a proportion of a total average thickness of layers each containing a polyethylene resin or a polypropylene resin as a principal component with respect to an average thickness of the multilayer film) is preferably 75%, more preferably 80%, still more preferably 85%, and yet more preferably 88%. By increasing the proportion, in the multilayer film, of the total average thickness of layers each containing a polyethylene resin or a polypropylene resin as a principal component, recyclability can be improved. The upper limit of the proportion, in the multilayer film, of the total average thickness of layers each containing a polyethylene resin or a polypropylene resin as a principal component is preferably 99.5%, and more preferably 99%, and may be 98%. The “total average thickness of layers each containing a polyethylene resin or a polypropylene resin as a principal component” as referred to herein means a total average thickness of a layer containing a polyethylene resin as a principal component and a layer containing a polypropylene resin as a principal component. The layers each containing a polyethylene resin or a polypropylene resin as a principal component are exemplified by: the layer (Y) in a case of the adhesive resin (B) being, e.g., an acid-modified polyethylene or an acid-modified polypropylene; and the layer (Z) in a case of the polyolefin resin (C) being a polyethylene or a polypropylene. The adhesive resin (B) and the polyolefin resin (C) are preferably of the same type of resins; for example, in a case where the adhesive resin (B) is an acid-modified polyethylene, the polyolefin resin (C) is preferably a polyethylene, and in a case where the adhesive resin (B) is an acid-modified polypropylene, the polyolefin resin (C) is preferably a polypropylene.

For example, the lower limit of the proportion, in the multilayer film of the present invention, of the total average thickness of layers each containing a polyethylene resin as a principal component is preferably 75%, more preferably 80%, still more preferably 85%, and yet more preferably 88%. The upper limit of the proportion, in the multilayer film, of the total average thickness of layers each containing a polyethylene resin as a principal component is preferably 99.5%, and more preferably 99%, and may be 98%.

Furthermore, the lower limit of the proportion, in the multilayer film of the present invention, of the total average thickness of layers each containing a polypropylene resin as a principal component is preferably 75%, more preferably 80%, still more preferably 85%, and yet more preferably 88%. The upper limit of the proportion, in the multilayer film, of the total average thickness of layers each containing a polypropylene resin as a principal component is preferably 99.5%, and more preferably 99%, and may be 98%.

The multilayer film of the present invention preferably does not include a layer containing as a principal component, a resin having a melting point of 200° C. or more, and a metal layer having an average thickness of 1 μm or more. Furthermore, it is preferred that none of the layer (X), the layer (Y), and the layer (Z) contain as a principal component, a resin having a melting point of 200° C. or more. Due to not including a layer containing as a principal component, a resin having a melting point of 200° C. or more, and a metal layer having an average thickness of 1 μm or more, heterogenous mixing with other components can be inhibited when ground matter of the multilayer film or the multilayer structure is melt formed. It is to be noted that the metal layer as referred to herein is a layer consisting of a metal such as an aluminum foil and having continuous and discontinuous faces.

### Method for Producing Multilayer Film

A method for producing the multilayer film (film forming method) is not particularly limited, and a conventional co-extrusion process, where each resin is extruded from separate dies or a common die and laminated, can be typically used. As the die, either an annular die or a T-die can be used. A process for uniaxially or biaxially stretching is not particularly limited, and the multilayer film can be produced by performing a stretching treatment in a machine direction of the film and/or a direction perpendicular to the machine direction, i.e., the transverse direction, by a conventional well-known stretching process such as roll-type uniaxial stretching, tenter-type uniaxial stretching, tubular-type simultaneous biaxial stretching, tenter-type sequential biaxial stretching, and tenter-type simultaneous biaxial stretching. Furthermore, in the tenter-type sequential biaxial stretching, tenter-type stretching may be used for both axes, or roll-type stretching and tenter-type stretching may be combined. Of these, the effects of the present invention may be particularly remarkably exhibited in a case of a multilayer film produced by the tenter-type sequential biaxial stretching in which roll-type stretching and tenter-type stretching are combined. A temperature during the stretching is typically 40 to 170° C., and more preferably 50 to 160° C., in light of processability. It is preferred that if necessary, after the stretching treatment, heat fixation, as generally referred to, is performed to heat the multilayer film at a temperature that is higher than or equal to a glass transition point and lower than a melting point to increase crystallinity and fix an orientation of a molecular chain.

In light of inhibiting the die buildup, the method for producing the multilayer film preferably includes: a step of melt kneading the gas barrier resin (a) and the polyolefin (b) to obtain pellets of the resin composition (A); and a step of melt forming the pellets of the resin composition (A) to form the layer (X). The specific method for obtaining the pellets of the resin composition (A) is as described above.

### Vapor-Deposited Multilayer Film

A vapor-deposited multilayer film of the present invention includes: the multilayer film of the present invention; and a vapor-deposited inorganic layer (I) laminated to an exposed-face side of the layer (X) of the multilayer film. In other words, the multilayer film of the present invention may be used with the vapor-deposited inorganic layer (I) laminated to a surface of the layer (X). The vapor-deposited inorganic layer (I) is preferably laminated directly to the exposed-face side of the layer (X) of the multilayer film or laminated to the exposed-face side via another layer such as an adhesion layer, and the vapor-deposited inorganic layer (I) is preferably directly laminated to the exposed-face side of the layer (X). The vapor-deposited inorganic layer (I) consists of an inorganic substance such as a metal or an inorganic oxide, and is a layer that has gas barrier properties against oxygen and water vapor. The layer (X) has higher affinity with a metal and/or an inorganic oxide than common thermoplastic resins, thereby enabling forming the vapor-deposited inorganic layer (I) so as to be compact and free from defect, and providing favorable interlayer adhesiveness between the layer (X) and the vapor-deposited inorganic layer (I) of a vapor-deposited multilayer film to be obtained. In addition, due to the layer (X) having the gas barrier properties, deterioration of the gas barrier properties can be inhibited even when bending or the like generates defects in the vapor-deposited inorganic layer (I). An average thickness of the vapor-deposited inorganic layer (I) is typically less than 500 nm. Due to the average thickness being less than 500 nm, viscosity stability during melt forming of the vapor-deposited multilayer film including the vapor-deposited inorganic layer (I) or ground matter of the multilayer structure can be superior, and generation of gels and aggregates can be inhibited.

The vapor-deposited inorganic layer (I) is preferably any one of a vapor-deposited metal layer containing aluminum as a principal component, and a vapor-deposited inorganic-oxide layer containing alumina or silica as a principal component. In a case in which light shielding properties are to be imparted, the vapor-deposited metal layer is preferred; however, the vapor-deposited inorganic-oxide layer is preferred in light of visibility of contents and/or oven suitability as a packaging material, as well as capabilities of inhibiting generation of gels and/or aggregates in melt forming of ground matter. Furthermore, in light of inhibiting coloring during recycling of the multilayer structure of the present invention, the vapor-deposited inorganic-oxide layer is preferred.

A content of aluminum atoms in the vapor-deposited metal layer is preferably 50 mol % or more, more preferably 70 mol % or more, still more preferably 90 mol % or more, and particularly preferably 95 mol % or more. An average thickness of the vapor-deposited metal layer is preferably 120 nm or less, more preferably 100 nm or less, and still more preferably 90 nm or less. In addition, the average thickness of the vapor-deposited metal layer is preferably 25 nm or more, more preferably 35 nm or more, and still more preferably 45 nm or more. It is to be noted that the average thickness of the vapor-deposited metal layer is an averaged value of thicknesses of cross sections of the vapor-deposited metal layer measured at ten arbitrary points by an electron microscope. In a case in which the vapor-deposited multilayer film of the present invention includes the vapor-deposited metal layer, the light transmittance at a wavelength of 600 nm can be 10% or less, leading to superior light shielding properties.

It is to be noted that in the vapor-deposited metal layer containing aluminum as a principal component, oxidation may irreversibly occur, and thus, a part of the vapor-deposited metal layer may contain aluminum oxide. The vapor-deposited metal layer (vapor-deposited inorganic layer (I)) containing aluminum as a principal component has a molar ratio (O mol/Al mol) of the content of oxygen atoms to the content of aluminum atoms of preferably 0.5 or less, more preferably 0.3 or less, and still more preferably 0.1 or less.

The vapor-deposited inorganic-oxide layer is exemplified by vapor-deposited films of: inorganic oxides such as, e.g., oxides of silicon, aluminum, magnesium, calcium, potassium, tin, sodium, boron, titanium, lead, zirconium, yttrium, or the like; and preferably alumina or silica. An average thickness of the vapor-deposited inorganic-oxide layer is preferably 60 nm or less, more preferably 50 nm or less, and still more preferably 40 nm or less. Also, the average thickness of the vapor-deposited inorganic-oxide layer is preferably 10 nm or more, more preferably 15 nm or more, and still more preferably 20 nm or more. It is to be noted that the average thickness of the vapor-deposited inorganic-oxide layer is an averaged value of thicknesses of cross sections of the vapor-deposited inorganic-oxide layer measured at ten arbitrary points by an electron microscope. In a case in which the vapor-deposited multilayer film of the present invention includes the vapor-deposited inorganic-oxide layer, the light transmittance at a wavelength of 600 nm can be 80% or more, and visibility of contents in a case of the vapor-deposited inorganic-oxide layer being used as a packaging material can be superior. In light of further improving the visibility, the light transmittance at a wavelength of 600 nm is more preferably 90% or more. The light transmittance can be increased by, for example, inhibiting thickness unevenness of the multilayer film used for the production of the multilayer film. As a means to further inhibit the thickness unevenness of the multilayer film is exemplified by a means of at least uniaxially stretching the multilayer film. The light transmittance of the vapor-deposited multilayer film at a wavelength of 600 nm is preferably 80% or more, and more preferably 90% or more.

The vapor-deposited inorganic layer (I) can be formed by a well-known physical vapor deposition process or chemical vapor deposition process. Specifically, the processes are exemplified by a vacuum vapor deposition process, a sputtering process, an ion plating process, an ion beam mixing process, a plasma CVD (chemical vapor deposition) process, a laser CVD process, a MO (metalorganic)-CVD process, a thermal CVD process, and the like; the physical vapor deposition process is preferably used, and of these, the vacuum vapor deposition process is particularly preferably used. The upper limit of a surface temperature of the layer (X) during the formation of the vapor-deposited inorganic layer (I) is preferably 60° C., more preferably 55° C., and still more preferably 50° C. Furthermore, the lower limit of the surface temperature of the layer (X) during the formation of the vapor-deposited inorganic layer (I) is not particularly limited, and 0° C. is preferred, 10° C. is more preferred, and 20° C. is still more preferred. Prior to conducting the film formation, the exposed face of the layer (X) may be subjected to a plasma treatment. As the plasma treatment, well-known processes can be used, and an atmospheric-pressure plasma treatment is preferred. In the atmospheric-pressure plasma treatment, nitrogen, helium, neon, argon, krypton, xenon, radon, or the like is used as discharge gas. Of these, nitrogen, helium, and argon are preferably used, and nitrogen is particularly preferred since cost can be reduced. A well-known protective layer or the like may be provided on the vapor-deposited inorganic layer (I) to improve bending resistance.

The multilayer film or the vapor-deposited multilayer film of the present invention has an oxygen transmission rate (under a condition involving 20° C. and 65% RH) of preferably less than 60 cc/(m²·day·atm), more preferably less than 10 cc/(m²·day·atm), still more preferably less than 3 cc/(m²·day·atm), and particularly preferably less than 0.5 cc/(m²·day·atm), as measured in accordance with JIS K 7126-2 (equal-pressure method; 2006). The multilayer film or the vapor-deposited multilayer film having the oxygen transmission rate falling within the range may have superior gas barrier properties.

### Multilayer Structure, Recovered Composition, Method for Recovering Multilayer Structure, and Packaging Material

Although the multilayer film or the vapor-deposited multilayer film itself of the present invention can be used as a packaging material having gas barrier properties, it can be laminated to at least one resin layer (R) containing a thermoplastic resin (D) as a principal component to provide a multilayer structure, whereby various functions as a packaging material such as a design and heat-sealing properties can be provided. In other words, the multilayer structure of the present invention is formed by laminating the multilayer film or the vapor-deposited multilayer film of the present invention to the at least one resin layer (R) containing the thermoplastic resin (D) as a principal component.

The thermoplastic resin (D) is not particularly limited and is exemplified by linear low-density polyethylenes, low-density polyethylenes, medium-density polyethylenes, high-density polyethylenes, vinyl ester resins, ethylene-propylene copolymers, polypropylenes, propylene-α-olefin copolymers (α-olefins having 4 to 20 carbon atoms), homopolymers of an olefin such as polybutene or polypentene and copolymers thereof, PAs such as nylon 6 and nylon 6,6, polyesters such as polyethylene terephthalate, polybutylene terephthalate, and polyethylene naphthalate, polystyrenes, polyvinyl chloride, polyvinylidene chloride, acrylic resins, polycarbonate, chlorinated polyethylenes, chlorinated polypropylenes, and the like. Of these, the polyolefins are preferred in light of superior moisture resistance, mechanical properties, economic efficiency, heat sealing properties, and the like, and the PAs and the polyesters are preferred in light of superior mechanical properties, heat resistance, and the like. In particular, in order to obtain a multilayer structure having superior recyclability, the thermoplastic resin (D) preferably is of the same type as the polyolefin resin (C) described above, i.e., the thermoplastic resin (D) preferably is a polyolefin resin having a melting point of less than 170° C., more preferably contains a polyethylene resin or a polypropylene resin as a principal component, still more preferably is a polyethylene or a polypropylene, and particularly preferably is a polyethylene. Therefore, in order to obtain a multilayer structure having superior recyclability, the polyolefin resin (C) and the thermoplastic resin (D) preferably each contain a polyethylene resin or a polypropylene resin as a principal component, more preferably are each a polyethylene or a polypropylene, and still more preferably are each a polyethylene. Such a resin layer (R) may be unstretched, or may be uniaxially or biaxially stretched or rolled. The resin layer (R) is preferably a biaxially stretched layer in light of improving mechanical strength, and is preferably an unstretched layer in light of improving heat-sealing properties.

A method for forming the resin layer (R) is not particularly limited, and the resin layer (R) is typically formed by melt extrusion with an extruder. As the die, either an annular die or a T-die can be used. A process for the uniaxial stretching or the biaxial stretching is not particularly limited, and the production can be performed by a stretching treatment in a machine direction of the film and/or a direction perpendicular to the machine direction, i.e., a transverse direction using a conventionally well-known stretching process such as roll-type uniaxial stretching, tubular-type simultaneous biaxial stretching, tenter-type sequential biaxial stretching, and tenter-type simultaneous biaxial stretching. As the stretch ratio, an area magnification is preferably set to 8 to 60 times in light of thickness uniformity and mechanical strength of a layer to be obtained. The area magnification is preferably 55 times or less, and more preferably 50 times or less. Furthermore, the area magnification is more preferably 9 times or more. When the area magnification is less than 8 times, stretching unevenness may remain, and when it is more than 60 times, the layer may become likely to break during the stretching.

An average thickness of the resin layer (R) is preferably 10 to 200 μm in light of industrial productivity. Specifically, in a case of an unstretched layer, the average thickness is more preferably 10 to 150 μm, and in a case of a biaxially stretched layer, the average thickness is more preferably 10 to 50 μm.

Moreover, an average thickness of the multilayer structure of the present invention is preferably 300 μm or less. When the average thickness falls within the above range, the multilayer structure of the present invention may be lightweight and flexible, and thus may be preferably used for soft packaging applications. In addition, the amount of resins used in the multilayer structure may be small, which may inhibit an environmental load.

An average thickness of each layer in the multilayer structure of the present invention can be appropriately adjusted in accordance with an intended usage, and at least one of the layer (Z) and the resin layer (R) preferably contains a polyethylene resin or a polypropylene resin as a principal component in light of inhibiting coloring during melt forming of the ground matter, improving thermal stability during the melt forming, and inhibiting generation of aggregates. A proportion of a total average thickness of layers each containing a polyethylene resin or a polypropylene resin as a principal component with respect to an average thickness of the multilayer structure is preferably 80% or more, and more preferably 85% or more. On the other hand, in light of improving gas barrier properties, this proportion is preferably 99.7% or less, and more preferably 99.5% or less, and may be 99.3% or less.

For example, the lower limit of a proportion, in the multilayer structure of the present invention, of a total average thickness of layers each containing a polyethylene resin as a principal component is preferably 80%, and more preferably 85%. The upper limit of the proportion, in the multilayer structure, of the total average thickness of layers each containing a polyethylene resin as a principal component is preferably 99.7%, and more preferably 99.5%, and may be 99.3%. Furthermore, the lower limit of a proportion, in the multilayer structure of the present invention, of a total average thickness of layers each containing a polypropylene resin as a principal component is preferably 80%, and more preferably 85%. The upper limit of the proportion, in the multilayer structure, of the total average thickness of layers each containing a polypropylene resin as a principal component is preferably 99.7%, and more preferably 99.5%, and may be 99.3%.

A process for laminating the resin layer (R) to the multilayer film or the vapor-deposited multilayer film of the present invention is not particularly limited, and is exemplified by extrusion lamination, co-extrusion lamination, dry lamination, and the like. When the resin layer (R) is laminated to the multilayer film or the vapor-deposited multilayer film, an adhesion layer may be provided. Furthermore, each layer constituting the multilayer structure of the present invention may be laminated via an adhesion layer as needed. However, it is preferred that there is no adhesion layer between the layer (X) and the layer (Y) and between the layer (Y) and the layer (Z) of the multilayer film or the vapor-deposited multilayer film. The adhesion layer can be formed by applying a well-known adhesive agent and drying it. The adhesive agent is preferably a two-component reactive polyurethane adhesive agent obtained by mixing a polyisocyanate component with a polyol component and allowing a reaction. An average thickness of the adhesion layer is not particularly limited, and is preferably 1 to 5 μm, and more preferably 2 to 4 μm.

The multilayer structure of the present invention is not particularly limited, and, for example, preferably has layer configurations as described below in light of obtaining a multilayer structure having superior recyclability. It is to be noted that in the layer configurations below, the layer (X), the layer (Y), the layer (Z), the vapor-deposited inorganic layer (I), and the layer (R) are expressed as X, Y, Z, I, and R, respectively, “/” is defined as direct lamination, and “//” is defined as lamination via an adhesion layer or direct lamination but the lamination via an adhesion layer is a preferred mode.

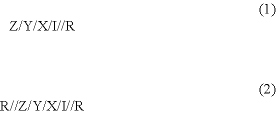

In the above layer configurations, the layer (X), the layer (Y), and the layer (Z) are each preferably at least uniaxially stretched, and more preferably biaxially stretched. It is preferred that the layer (Z) and the layer (R) are each a polyethylene resin or a polypropylene resin, and that the layer (Y) is a maleic anhydride-modified polyethylene or a maleic anhydride-modified polypropylene. Moreover, it is preferred that as both outermost layers of the multilayer structure of the present invention, layers each containing a polyethylene resin or a polypropylene resin as a principal component are provided, such that when the packaging material or the like of the present invention is recycled, ground matter obtained by grinding the packaging material can be recovered as a composition that mainly contains the polyethylene resin or the polypropylene resin. In other words, in a case in which the resin layer (R) is positioned as both the outermost layers, the resin layer (R) is preferably a layer containing a polyethylene resin or a polypropylene resin as a principal component, and in a case in which the layer (Z) and the resin layer (R) are positioned as both the outermost layers, respectively, it is preferred that the layer (Z) and the resin layer (R) are each a layer containing a polyethylene resin or a polypropylene resin as a principal component. In some cases, one of the layers positioned as the outermost layers is preferably an unstretched layer, and the other layer is preferably an at least uniaxially stretched layer in light of obtaining a multilayer structure that achieves both heat-sealing properties and mechanical properties.

The multilayer structure of the present invention may include another layer aside from those described above, within a range not leading to impairment of the effects of the present invention. The another layer is exemplified by a recovered layer. In particular, it is preferred to reuse, as a part or all of the recovered layer, a recovered composition containing a recovered material of the multilayer structure of the present invention described later. The another layer is also exemplified by a printed layer. The printed layer may be included at any position of the multilayer structure of the present invention. The printed layer is exemplified by a film obtained by applying and drying a solution containing a pigment or a dye, and, if necessary, a binder resin. A process for applying the printed layer is exemplified by a gravure printing process, and various applying processes using a wire bar, a spin coater, a die coater, or the like. An average thickness of the ink layer is not particularly limited, and is preferably 0.5 to 10 μm, and more preferably 1 to 4 μm.

It is preferred to reuse a recovered material (scrap) that is a recovered remnant and/or a recovered defective product generated during production of the multilayer structure of the present invention. A method for recovering a multilayer structure, the method including a step of melt forming the multilayer structure of the present invention after the multilayer structure is ground; and a recovered composition containing the recovered material of the multilayer structure of the present invention are also suitable embodiments of the present invention.

When the multilayer structure of the present invention is recovered, first, a recovered material of the multilayer structure of the present invention is ground. The ground recovered material may be directly melt formed to give a recovered composition, or may be melt formed together with other component as needed to give a recovered composition. A preferred component to be added to the recovered material is preferably a polyolefin resin, and more preferably a polyethylene resin or a polypropylene resin. As the polyolefin resin, the same type as the polyolefin resin (C) described above as a polyolefin resin to be used in the multilayer film of the present invention is used. The ground recovered material may be directly used for production of a formed article such as a multilayer structure, or the ground recovered material may be melt formed to give pellets consisting of the recovered composition, and then the pellets may be used for production of a formed article.

In the recovered composition, a mass ratio of the resin composition (A) to the polyolefin resin [resin composition (A)/polyolefin resin] is preferably 0.01/99.99 to 20/80. In a case in which this mass ratio is 0.01/99.99 or more, a usage proportion of the recovered material may increase. On the other hand, when the mass ratio is 20/80 or less, melt formability and mechanical properties of the recovered composition may improve. In light of improving melt formability and mechanical properties of a recovered composition to be obtained, the mass ratio is more preferably 15/85 or less, and more preferably 10/90 or less, and may be 5/95 or less.

Since the multilayer structure of the present invention has gas barrier properties and recyclability, it can be suitably used as various packaging materials such as food packaging, medical drug packaging, industrial chemical packaging, pesticide packaging, and the like. In particular, the packaging material including the multilayer structure of the present invention can be suitably used as a packaging material having superior recyclability. The multilayer film and the vapor-deposited multilayer film of the present invention can also be suitably used as packaging materials.

### EXAMPLES

Hereinafter, the present invention is specifically explained by way of Examples, but the present invention is not in anyhow limited to these Examples.

### Materials Used

### Gas Barrier Resin (a)

EVOH (a-1): EVOH (ethylene (Et) unit content of 32 mol %; degree of saponification of 99.99 mol %; MFR (190° C.; load of 2.160 kg) of 1.6 g/10 min; melting point of 183° C.; content of volatiles of 0.8%; containing sodium acetate at a concentration of 180 ppm in terms of sodium ion equivalent, phosphate ion at a concentration of 30 ppm in terms of phosphate radical equivalent, and boric acid at a concentration of 150 ppm in terms of boron element equivalent, and containing no multivalent metal ion)
EVOH (a-1A): EVOH (ethylene unit content of 32 mol %; degree of saponification of 99.99 mol %; MFR (190° C.; load of 2.160 kg) of 1.6 g/10 min; melting point of 183° C.; content of volatiles of 0.8%; containing phosphate ion at a concentration of 30 ppm in terms of phosphate radical equivalent, and boric acid at a concentration of 150 ppm in terms of boron element equivalent, and containing no alkali metal ion and no multivalent metal ion)
EVOH (a-1B): EVOH (ethylene unit content of 32 mol %; degree of saponification of 99.99 mol %; MFR (190° C.; load of 2.160 kg) of 1.6 g/10 min; melting point of 183° C.; content of volatiles of 0.8%; containing sodium acetate at a concentration of 150 ppm in terms of sodium ion equivalent, phosphate ion at a concentration of 30 ppm in terms of phosphate radical equivalent, and boric acid at a concentration of 150 ppm in terms of boron element equivalent, and containing no multivalent metal ion)
EVOH (a-1C): EVOH (ethylene unit content of 32 mol %; degree of saponification of 99.99 mol %; MFR (190° C.; load of 2.160 kg) of 1.6 g/10 min; melting point of 183° C.; content of volatiles of 0.8%; containing sodium acetate at a concentration of 250 ppm in terms of sodium ion equivalent, phosphate ion at a concentration of 30 ppm in terms of phosphate radical equivalent, and boric acid at a concentration of 150 ppm in terms of boron element equivalent, and containing no multivalent metal ion)
EVOH (a-1D): EVOH (ethylene unit content of 32 mol %; degree of saponification of 99.99 mol %; MFR (190° C.; load of 2.160 kg) of 1.6 g/10 min; melting point of 183° C.; content of volatiles of 0.8%; containing sodium acetate at a concentration of 550 ppm in terms of sodium ion equivalent, phosphate ion at a concentration of 30 ppm in terms of phosphate radical equivalent, and boric acid at a concentration of 150 ppm in terms of boron element equivalent, and containing no multivalent metal ion)
EVOH (a-2): EVOH (ethylene unit content of 27 mol %; degree of saponification of 99.99 mol %; MFR (210° C.; load of 2.160 kg) of 4.0 g/10 min; melting point of 191° C.; content of volatiles of 0.8%; containing sodium acetate at a concentration of 180 ppm in terms of sodium ion equivalent, phosphate ion at a concentration of 30 ppm in terms of phosphate radical equivalent, and boric acid at a concentration of 150 ppm in terms of boron element equivalent, and containing no multivalent metal ion)
EVOH (a-3): EVOH (ethylene unit content of 44 mol %; degree of saponification of 99.99 mol %; MFR (190° C.; load of 2.160 kg) of 5.7 g/10 min; melting point of 165° C.; content of volatiles of 0.8%; containing sodium acetate at a concentration of 180 ppm in terms of sodium ion equivalent, and phosphate ion at a concentration of 30 ppm in terms of phosphate radical equivalent, and containing no multivalent metal ion)
EVOH (a-2/3): A mixture (dry blend) of the EVOH (a-2) and the EVOH (a-3) in a mass ratio of 75/25
EVOH (a-4): EVOH (ethylene unit content of 48 mol %; degree of saponification of 99.99 mol %; MFR (190° C.; load of 2.160 kg) of 6.4 g/10 min; melting point of 157° C.; content of volatiles of 0.8%; containing sodium acetate at a concentration of 180 ppm in terms of sodium ion equivalent, and phosphate ion at a concentration of 50 ppm in terms of phosphate radical equivalent, and containing no multivalent metal ion)
EVOH (a-5): EVOH produced by the following producing method (ethylene unit content of 44 mol %; degree of saponification of 99.99 mol %; epoxypropane-modified degree of 4.6 mol %; MFR (190° C.; load of 2.160 kg) of 5.6 g/10 min; content of volatiles of 0.8%; melting point of 119° C.; containing sodium acetate at a concentration of 220 ppm in terms of sodium ion equivalent, and phosphate ion at a concentration of 30 ppm in terms of phosphate radical equivalent); it is to be noted that the epoxypropane-modified degree is a content of monomer units modified by epoxypropane with respect to total monomer units. Method for Producing EVOH (a-5)

28 parts by mass of zinc acetylacetonate monohydrate and 957 parts by mass of 1,2-dimethoxyethane were mixed to give a mixed solution. To the mixed solution thus obtained, 15 parts by mass of trifluoromethanesulfonic acid was added with stirring, to give a catalyst solution. Then, an EVOH having an ethylene unit content of 44 mol % and a degree of saponification of 99.99 mol % or more (containing no alkali metal ion, and containing phosphate ion at a concentration of 30 ppm) was charged into TEM-35BS, an extruder manufactured by Toshiba Machine Co., Ltd. (37 mmφ, L/D=52.5), and the extruder was operated under the conditions: a barrel C1 was cooled with water, barrels C2 to C3 were at 200° C., barrels C4 to C15 were at 240° C., and a screw rotation speed was 250 rpm. Epoxypropane (1.5 kg/hr) and the catalyst solution were added from a pressure inlet 1 of C8. Next, an aqueous solution of sodium acetate was added from a pressure inlet 2 of C13. Discharged strands were solidified by cooling in a cooling bath, followed by cutting and then drying to give an EVOH (a-5). In this step, an addition amount of the catalyst solution was adjusted such that a melting point of the EVOH (a-5) to be obtained became 119° C. It is to be noted that an addition amount of the aqueous solution of sodium acetate was appropriately adjusted such that the sodium ion content in the EVOH (a-5) would be as described above.
PA (a-6): nylon 6/66 (“Ultramid (trademark) C40LN”, manufactured by BASF) Polyolefin (b)
Polyolefin (b-1): saponified product of EVA (“Melthene (trademark) H-6822X”, manufactured by Tosoh Corporation; ethylene unit content of 94 mol %; degree of saponification of 92 mol %; MFR (190° C., load of 2.160 kg) of 190 g/10 min; number-average molecular weight (Mn) of 16,800)
Polyolefin (b-2): saponified product of EVA (“Melthene (trademark) H-6051K”, manufactured by Tosoh Corporation; ethylene unit content of 89 mol %; degree of saponification of 97 mol %; MFR (190° C., load of 2.160 kg) of 6.2 g/10 min; number-average molecular weight (Mn) of 24,300)
Polyolefin (b-3): EVA (“Ultrathene (trademark) 680”, manufactured by Tosoh Corporation; ethylene unit content of 93 mol %; MFR (190° C., load of 2.160 kg) of 150 g/10 min; number-average molecular weight (Mn) being unknown)
Polyolefin (b-4): polyethylene (“SANWAX (trademark) 161-P”, manufactured by Sanyo Chemical Industries, Ltd.; MFR (190° C., load of 2.160 kg) of more than 1,000 g/10 min; melt viscosity (BL viscometer; 140° C.) of 4,200 mPa·s; number-average molecular weight (Mn) of 5,000)
Polyolefin (b-5): partially saponified EVA (ethylene unit content of 93 mol %; degree of saponification of 50 mol %; MFR (190° C., load of 2.160 kg) of 120 g/10 min, number-average molecular weight (Mn) being unknown) obtained by saponifying, by a well-known procedure, EVA (“Ultrathene (trademark) 680”, manufactured by Tosoh Corporation; ethylene unit content of 93 mol %; MFR (190° C., load of 2.160 kg) of 150 g/10 min)
Polyolefin (b-6): EVA (“Ultrathene (trademark) 636”, manufactured by Tosoh Corporation; ethylene unit content of 89 mol %; MFR (190° C., load of 2.16 kg) of 2.5 g/10 min, number-average molecular weight (Mn) being unknown)

It is to be noted that the MFR of the gas barrier resin (a) and the polyolefin (b) was measured in accordance with JIS K7210-1 (2014).

### Example 1

### (1) Production of Resin Composition (A) Containing Gas Barrier Resin (a) for Layer (X)

100 parts by mass of pellets of the EVOH (a-1), 2 parts by mass of pellets of the polyolefin (b-1), and calcium stearate were dry blended such that the calcium ion content in a resin composition to be obtained would be 250 ppm, and then the mixture was melt kneaded to give pellets of the resin composition (A) for the layer (X). An extruder used for the melt kneading was a twin-screw extruder having D (mm)=25, and included fully intermeshing co-rotation-type screws each having L/D=30. In the middle of the screw, a mixing zone was positioned where a feeding-type kneading disk, a neutral-type kneading disk, and a return-type kneading disk were in series, with one vacuum vent arranged downstream from the mixing zone. The resin temperature was set to 230° C.

### (2) Thermogravimetry (TG) of Pellets of Resin Composition (A)

Thus obtained pellets of the resin composition (A) were used to conduct thermogravimetry (TG) under conditions of maintaining the pellets at 200° C. for 30 minutes in a nitrogen atmosphere to measure a weight loss (W). The results are shown in Table 1.

### (3) Resin Composition Containing Adhesive Resin (B) for Layer (Y)

A maleic anhydride-modified polyethylene “ADMER (trademark) NF518”, manufactured by Mitsui Chemicals, Inc. (MFR (190° C., load of 2.160 kg) of 3.1 g/10 min; melting point of 121° C.; density of 0.91 g/cm³; acid number of 1.8 mg KOH/g), which served as the adhesive resin (B), was directly used as pellets of a resin composition for the layer (Y).

It is to be noted that herein, a substance consisting substantially only of one type of component is also referred to as a composition.

### (4) Resin Composition Containing Polyolefin Resin (C) for Layer (Z)

A low-density polyethylene “INNATE (trademark) TF80”, manufactured by DOW Inc. (MFR (190° C., load of 2.160 kg) of 1.6 g/10 min; melting point of 124° C.; density of 0.926 g/cm³), which served as the polyolefin resin (C), was directly used as pellets of a resin composition for the layer (Z).

### (5) Production of Multilayer Film

The pellets of each of the resin compositions obtained in (1), (3), and (4) described above were used to produce a multilayer film having average thicknesses and a layer configuration of (X)/(Y)/(Z)=4 μm/4 μm/32 μm=EVOH 4/Tie 4/PE 32 by using co-extrusion film formation equipment. The extruders were each a single-screw extruder having D (mm)=30, and each included a full flight screw having L/D=28 and a compression ratio of 3.0. As the die, a feedblock-laminating T-die having a width of 350 mm was used. Temperature conditions in this procedure are shown below. It is to be noted that a proportion, in the multilayer film, of a total average thickness of layers each containing a polyethylene resin as a principal component (PO thickness proportion) was 90%.
extrusion temperatures of resin composition (A): feeding zone/compression zone/metering zone/adapter=175° C./220° C./220° C./220° C.
extrusion temperatures of resin composition containing adhesive resin (B): feeding zone/compression zone/metering zone/adapter=175° C./220° C./220° C./220° C.
extrusion temperatures of resin composition containing polyolefin resin (C): feeding zone/compression zone/metering zone/adapter=175° C./220° C./220° C./220° C.
die temperature: 240° C.
temperature of cooling rolls: 50° C.

### (6) Die Buildup Evaluation

The production of the multilayer film of (5) described above was continuously carried out for 6 hours, and die buildup generated near the T-die lip on the layer (X) side after 6 hours was visually evaluated and determined in accordance with the following criteria. It is to be noted that in a case of the determination being E, it was assessed that the die buildup properties were poor (inhibiting die buildup failed). The results are shown in Table 2.

### Determination: Criteria

A: no generation of die buildup being observed across whole width even after 6 hours of operation
B: generation of slight die buildup being observed after 6 hours of operation
C: generation of die buildup being observed after 4 hours of operation, and then increase in die buildup being observed
D: generation of die buildup being observed after 2 hours of operation, and then increase in die buildup being observed
E: generation of die buildup being observed after 1 hour of operation, and then increase in die buildup being observed

### (7) Oxygen Transmission Rate of Multilayer Film

On the multilayer film obtained in (5) described above, an oxygen transmission rate was measured in accordance with the method described in JIS K 7126-2 (equal-pressure method; 2006), in which the layer (Z) was positioned on an oxygen supply side. Specifically, using an oxygen transmission measuring device (“MOCON OX-TRAN2/21”, manufactured by Modern Controls Inc.), an oxygen transmission rate (unit: cc/(m²·day·atm)) was measured under the conditions involving: temperature: 20° C., humidity of the oxygen supply side: 65% RH, humidity of the carrier gas side: 65% RH, oxygen pressure: 1 atm, and carrier gas pressure: 1 atm, and determined in accordance with the following criteria. As the carrier gas, a nitrogen gas containing a 2% by volume hydrogen gas was used. It is to be noted that in the case of the determination being E, it was assessed that the gas barrier properties were inferior. The results are shown in Table 2.

### Determination: Criteria

A: less than 1 cc/(m²·day·atm)
B: 1 cc/(m²·day·atm) or more and less than 3 cc/(m²·day·atm)
C: 3 cc/(m²·day·atm) or more and less than 10 cc/(m²·day·atm)
D: 10 cc/(m²·day·atm) or more and less than 60 cc/(m²·day·atm)
E: 60 cc/(m²·day·atm) or more

### (8) Production of Multilayer Structure

A two-component reactive polyurethane adhesive agent (24 parts by mass of “TAKELAC (trademark) A-520” and 4 parts by mass of “TAKENATE (trademark) A-50”, manufactured by Mitsui Chemicals, Inc.) and 37 parts by mass of ethyl acetate were mixed to prepare an adhesive agent solution. Next, the adhesive agent solution was applied with a wire bar to a corona-treated face of a resin layer (R) (an LLDPE film having an average thickness of 50 μm (“Unilax (trademark) LS-760C”, manufactured by Idemitsu Unitech Co., Ltd.)), such that the average thickness after drying became 2 μm, and the adhesive agent solution was dried at 100° C. for 5 minutes to laminate the resin layer (R) to the multilayer film obtained in (5) described above to produce a multilayer structure having average thicknesses and a layer configuration of (R)/adhesive agent/(X)/(Y)/(Z)=50 μm/2 μm/4 μm/4 μm/32 μm. An adhesion temperature during the lamination (heating roll temperature) was set to 80° C., followed by aging at 40° C. for 3 days.

### (9) Coloring Evaluation and Recyclability Evaluation of Multilayer Structure

Ground matter obtained by grinding the multilayer structure obtained in (8) described above into a size of 4 mm² or smaller, and a low-density polyethylene (LDPE) “Novatec (trademark) LD LJ400” (MFR (190° C., load of 2.160 kg) of 1.5 g/10 min; melting point of 111° C.; density of 0.921 g/cm³), manufactured by Japan Polyethylene Corporation, were dry blended in a mass ratio (recovered material/low-density polyethylene) of 50/50, and monolayer film formation was carried out under the extrusion conditions described below to give a monolayer film (recovered material) having an average thickness of 100 μm. Furthermore, as a control, a monolayer film similarly having an average thickness of 100 μm (hereinafter, may be simply referred to as “control”) was obtained using only the low-density polyethylene. The extruder was a single-screw extruder having (D) (mm)=20, and included a full flight screw having L/D=20 and a compression ratio of 3.5. As the die, a T-die having a width of 300 mm was used. An average thickness of the monolayer film was adjusted by appropriately changing screw rotation speed and roll drawing speed. Temperature conditions in this procedure are shown below.
extrusion temperatures: feeding zone/compression zone/metering zone/adapter=175° C./220° C./220° C./220° C.
die temperature: 220° C.
temperature of cooling rolls: 80° C.

The coloring state and defects of the monolayer film obtained (recovered material) were visually compared with the control, and determined in accordance with the following criteria. It is to be noted that in the case of the evaluation of defects being E, it was assessed that the recyclability was insufficient. The results are shown in Table 2.

### Determination of Coloring: Criteria

A: smaller degree of hue change being observed, compared to the control
B: mild coloring being observed, compared to the control
C: moderate coloring being observed, compared to the control
D: significant coloring being observed, compared to the control
E: significant coloring being observed, compared to the control, and unevenness being also observed

### Determination of Defects (Recyclability): Criteria

A: the amount of aggregates being almost the same as that of the control
B: the amount of small aggregates being slightly larger than that of the control
C: the amount of small aggregates being larger than that of the control
D: the amount of large aggregates being larger than that of the control
E: the amount of large aggregates being much larger than that of the control

Examples 2 to 23, 35, and 36, and Comparative Examples 3 and 4 Resin composition pellets, a multilayer film, and a multilayer structure were produced and evaluated similarly to Example 1, except that the type of the gas barrier resin (a), the type and the content of the polyolefin (b), the content of the alkali metal ion (c), and the type and the content of the multivalent metal ion (d) were as shown in Table 1 or 3. It is to be noted that in Tables 1 and 3, the content of the alkali metal ion (c) and the content of the multivalent metal ion (d) are each a content with respect to a total mass of the resin composition (A). The results are shown in Tables 1 to 4. It is to be noted that in Examples 12 and 13, magnesium stearate was used instead of calcium stearate, and in Examples 16 and 17, zinc stearate was used instead of calcium stearate. In addition, in Examples 18 and 23, calcium stearate was not added during the melt kneading in “(1) Production of Resin Composition (A) Containing Gas Barrier Resin (a) for Layer (X)” in Example 1.

### Example 24

Pellets of a resin composition containing a gas barrier resin were produced similarly to Example 1, except that the polyolefin (b-1) was not added. Subsequently, a multilayer film and a multilayer structure were produced and evaluated similarly to Example 1, except that a dry blend obtained by dry blending 100 parts by mass of the obtained resin composition and 2 parts by mass of pellets of the polyolefin (b-1) was used as the resin composition for the layer (X). The results are shown in Tables 3 and 4.

### Example 25

Resin composition pellets and a multilayer film were produced, and various measurements and evaluations were conducted similarly to Example 1, except for using an open vent instead of a vacuum vent during production of pellets of the resin composition (A) for the layer (X). The results are shown in Tables 3 and 4.

### Example 26

Resin composition pellets and a multilayer film were produced, and various measurements and evaluations were conducted similarly to Example 1, except that a vacuum vent was not used during production of the pellets of the resin composition (A) for the layer (X). The results are shown in Tables 3 and 4.

### Example 27

Resin composition pellets, a multilayer film, a vapor-deposited multilayer film, and a multilayer structure were produced and evaluated similarly to Example 1, except that a vapor-deposited alumina (AlOx) layer (vapor-deposited inorganic layer (I)) having an average thickness of 30 nm was laminated by a well-known vacuum vapor deposition process to a surface of the layer (X) of the multilayer film obtained in (5) described above to produce a vapor-deposited multilayer film, and, instead of a multilayer film, the vapor-deposited multilayer film was used for production of the multilayer structure. The results are shown in Tables 3 and 4. It is to be noted that the measurement of an oxygen transmission rate was conducted on the vapor-deposited multilayer film.

### Example 28

Resin composition pellets, a multilayer film, a vapor-deposited multilayer film, and a multilayer structure were produced and evaluated similarly to Example 27, except that the vapor-deposited alumina layer was changed to a vapor-deposited silica (SiOx) layer. The results are shown in Tables 3 and 4.

### Example 29

Resin composition pellets, a multilayer film, a vapor-deposited multilayer film, and a multilayer structure were produced and evaluated similarly to Example 27, except that the vapor-deposited alumina layer was changed to a vapor-deposited aluminum (Al) layer having an average thickness of 50 nm. The results are shown in Tables 3 and 4.

### Example 30

Resin composition pellets, a multilayer film, and a multilayer structure were produced, and various measurements and evaluations were conducted similarly to Example 1, except that an average thickness of each layer of the multilayer film was changed as shown in Table 4. The results are shown in Tables 3 and 4.

### Example 31

Resin composition pellets, a multilayer film, and a multilayer structure were produced, and various measurements and evaluations were conducted similarly to Example 1, except that the pellets of each of the resin compositions obtained in (1), (3), and (4) described above were used to produce a co-extruded film having average thicknesses and a layer configuration of (X)/(Y)/(Z)=20 μm/20 μm/160 μm=EVOH 20/Tie 20/PE 160, the co-extruded film was stretched by 5 times in a longitudinal direction (MD) to produce a multilayer film having average thicknesses and a layer configuration of 4 μm/4 μm/32 μm=EVOH 4/Tie 4/PE 32, and the multilayer film was used. The results are shown in Tables 3 and 4.

### Example 32

Resin composition pellets, a multilayer film, and a multilayer structure were produced and evaluated similarly to Example 1, except that: pellets of a resin composition containing a gas barrier resin were produced similarly to Example 1, except that the EVOH (a-5) was used instead of the EVOH (a-1); the obtained resin composition pellets and the pellets of each of the resin compositions obtained in (3) and (4) described above were used to produce a co-extruded film having average thicknesses and a layer configuration of (X)/(Y)/(Z)=128 μm/128 μm/1024 μm=EVOH 128/Tie 128/PE 1024; the co-extruded film was stretched by 4 times in the longitudinal direction (MD) and then by 8 times in the width direction (TD) to produce a multilayer film having average thicknesses and a layer configuration of 4 μm/4 μm/32 μm=EVOH 4/Tie 4/PE 32; and the multilayer film was used. The results are shown in Tables 3 and 4.

### Example 33

Resin composition pellets, a multilayer film, and a multilayer structure were produced and evaluated similarly to Example 1, except that: a maleic anhydride-modified polypropylene “ADMER (trademark) QF551”, manufactured by Mitsui Chemicals, Inc. (MFR (230° C., load of 2.160 kg) of 5.7 g/10 min; melting point of 144° C.; density of 0.89 g/cm³) was used as the adhesive resin (B); a polypropylene “Novatec (trademark) PP EA7AD”, manufactured by Japan Polypropylene Corporation (MFR (230° C., load of 2.160 kg) of 1.4 g/10 min; melting point of 161° C.; density of 0.90 g/cm³) was used as the polyolefin resin (C); and a polypropylene film having an average thickness of 50 μm was used as the resin layer (R); temperature conditions during the production of the multilayer film were changed as described below. The results are shown in Tables 3 and 4.
extrusion temperatures of resin composition (A): feeding zone/compression zone/metering zone/adapter=175° C./220° C./220° C./230° C.
extrusion temperatures of resin composition containing adhesive resin (B): feeding zone/compression zone/metering zone/adapter=175° C./230° C./230° C./230° C.
extrusion temperatures of resin composition containing polyolefin resin (C): feeding zone/compression zone/metering zone/adapter=175° C./230° C./230° C./230° C.
die temperature: 240° C.
temperature of cooling rolls: 50° C.

### Comparative Example 1

A multilayer film and a multilayer structure were produced and evaluated similarly to Example 1, except that the layer (Z) (monolayer film) having an average thickness of 40 μm was used instead of a multilayer film. It is to be noted that the layer (Z) having an average thickness of 40 μm was formed by extruding only a resin composition containing the polyolefin resin (C) (a low-density polyethylene “INNATE (trademark) TF80”, manufactured by DOW Inc.), rather than simultaneously extruding the resin composition (A) and the adhesive resin (B), and adjusting the average thickness, in the formation of the multilayer film in Example 1. The results are shown in Tables 3 and 4.

### Comparative Example 2

Resin composition pellets, a multilayer film, and a multilayer structure were produced, and various measurements and evaluations were conducted similarly to Example 1, except that the polyolefin (b-1) was not added. The results are shown in Tables 3 and 4.

### Example 34

100 parts by mass of pellets of the PA (a-6) and 2 parts by mass of pellets of the polyolefin (b-1) were dry blended and then melt kneaded to give pellets of the resin composition (A) for the layer (X). An extruder used for the melt kneading was a twin-screw extruder having D (mm)=25, and included fully intermeshing co-rotation-type screws each having L/D=30. A multilayer film and a multilayer structure were produced, and various performance characteristics were evaluated similarly to Example 1, except that the pellets of the resin composition (A) obtained in the present Example were used as pellets of the resin composition (A). The results are shown in Tables 3 and 4.

### Comparative Example 5

A resin composition, a multilayer film, and a multilayer structure were produced and evaluated similarly to Example 34, except that the polyolefin (b-1) was not used. The results are shown in Tables 3 and 4.

TABLE 1

| | Resin composition (A) | | | | | | | |
|---|---|---|---|---|---|---|---|---|
| | gas barrier resin (a) | | | | polyolefin (b) | | | |
| | | | Et | | | Et | degree of | |
| | | | unit | melting | | unit | saponi- | MFR |
| | type | resin | content | point | type | content | fication | g/10 |
| | — | — | mol % | ° C. | — | mol % | mol % | min |
| Example 1 | a-1 | EVOH | 32 | 183 | b-1 | 94 | 92 | 190 |
| Example 2 | a-1 | EVOH | 32 | 183 | b-2 | 89 | 97 | 6.2 |
| Example 3 | a-1 | EVOH | 32 | 183 | b-3 | 93 | 0 | 150 |
| Example 4 | a-1 | EVOH | 32 | 183 | b-4 | 100 | — | >1,000 |
| Example 5 | a-1 | EVOH | 32 | 183 | b-5 | 93 | 50 | 120 |
| Example 6 | a-2 | EVOH | 27 | 191 | b-1 | 94 | 92 | 190 |
| Example 7 | a-3 | EVOH | 44 | 165 | b-1 | 94 | 92 | 190 |
| Example 8 | a-2/3 | EVOH | 27/44 | 191/165 | b-1 | 94 | 92 | 190 |
| Example 9 | a-4 | EVOH | 48 | 157 | b-1 | 94 | 92 | 190 |
| Example 10 | a-1 | EVOH | 32 | 183 | b-1 | 94 | 92 | 190 |
| Example 11 | a-1 | EVOH | 32 | 183 | b-1 | 94 | 92 | 190 |
| Example 12 | a-1 | EVOH | 32 | 183 | b-1 | 94 | 92 | 190 |
| Example 13 | a-1 | EVOH | 32 | 183 | b-1 | 94 | 92 | 190 |
| Example 14 | a-1 | EVOH | 32 | 183 | b-1 | 94 | 92 | 190 |
| Example 15 | a-1 | EVOH | 32 | 183 | b-1 | 94 | 92 | 190 |
| Example 16 | a-1 | EVOH | 32 | 183 | b-1 | 94 | 92 | 190 |
| Example 17 | a-1 | EVOH | 32 | 183 | b-1 | 94 | 92 | 190 |
| Example 18 | a-1 | EVOH | 32 | 183 | b-1 | 94 | 92 | 190 |
| Example 19 | a-1A | EVOH | 32 | 183 | b-1 | 94 | 92 | 190 |
| Example 20 | a-1B | EVOH | 32 | 183 | b-1 | 94 | 92 | 190 |
| | | Resin composition (A) | | | | | | |
| | | polyolefin (b) | | alkali | | multivalent | | |
| | | | content | metal | | metal | | thermo- |
| | | | parts | ion (c) | | ion (d) | | gravimetry |
| | | Mn | by | type | content | type | content | W |
| | | — | mass | — | ppm | — | ppm | % |
| | Example 1 | 16,800 | 2 | Na | 176 | Ca | 250 | 0.06 |
| | Example 2 | 24,300 | 2 | Na | 176 | Ca | 250 | 0.06 |
| | Example 3 | — | 2 | Na | 176 | Ca | 250 | 0.06 |
| | Example 4 | 5,000 | 2 | Na | 176 | Ca | 250 | 0.06 |
| | Example 5 | — | 2 | Na | 176 | Ca | 250 | 0.06 |
| | Example 6 | 16,800 | 2 | Na | 176 | Ca | 250 | 0.06 |
| | Example 7 | 16,800 | 2 | Na | 176 | Ca | 250 | 0.06 |
| | Example 8 | 16,800 | 2 | Na | 176 | Ca | 250 | 0.06 |
| | Example 9 | 16,800 | 2 | Na | 176 | Ca | 250 | 0.06 |
| | Example 10 | 16,800 | 5 | Na | 171 | Ca | 250 | 0.06 |
| | Example 11 | 16,800 | 10 | Na | 164 | Ca | 250 | 0.06 |
| | Example 12 | 16,800 | 2 | Na | 176 | Mg | 250 | 0.06 |
| | Example 13 | 16,800 | 2 | Na | 176 | Mg | 50 | 0.06 |
| | Example 14 | 16,800 | 2 | Na | 176 | Ca | 50 | 0.06 |
| | Example 15 | 16,800 | 2 | Na | 176 | Ca | 1,200 | 0.06 |
| | Example 16 | 16,800 | 2 | Na | 176 | Zn | 250 | 0.06 |
| | Example 17 | 16,800 | 2 | Na | 176 | Zn | 50 | 0.06 |
| | Example 18 | 16,800 | 2 | Na | 176 | — | 0 | 0.06 |
| | Example 19 | 16,800 | 2 | — | 0 | Ca | 250 | 0.06 |
| | Example 20 | 16,800 | 2 | Na | 98 | Ca | 250 | 0.06 |

TABLE 2

| | Multilayer film | | | | | | |
|---|---|---|---|---|---|---|---|
| | | stretch | PO | | oxygen | Recovered composition | |
| | layer configuration and | ratio | thickness | die | transmission | | defects |
| | average thicknesses | MD × TD | proportion | buildup | rate | coloring | (recyclability) |
| | μm | — | % | — | * | — | — |
| Example 1 | EVOH 4/Tie 4/PE 32 | unstretched | 90 | B | B | B | B |
| Example 2 | EVOH 4/Tie 4/PE 32 | unstretched | 90 | C | B | B | B |
| Example 3 | EVOH 4/Tie 4/PE 32 | unstretched | 90 | C | B | B | C |
| Example 4 | EVOH 4/Tie 4/PE 32 | unstretched | 90 | B | B | B | C |
| Example 5 | EVOH 4/Tie 4/PE 32 | unstretched | 90 | D | B | B | C |
| Example 6 | EVOH 4/Tie 4/PE 32 | unstretched | 90 | B | A | C | C |
| Example 7 | EVOH 4/Tie 4/PE 32 | unstretched | 90 | A | B | A | A |
| Example 8 | EVOH 4/Tie 4/PE 32 | unstretched | 90 | A | A | B | B |
| Example 9 | EVOH 4/Tie 4/PE 32 | unstretched | 90 | A | B | A | A |
| Example 10 | EVOH 4/Tie 4/PE 32 | unstretched | 90 | B | B | B | C |
| Example 11 | EVOH 4/Tie 4/PE 32 | unstretched | 90 | B | C | B | D |
| Example 12 | EVOH 4/Tie 4/PE 32 | unstretched | 90 | B | B | C | B |
| Example 13 | EVOH 4/Tie 4/PE 32 | unstretched | 90 | C | B | B | B |
| Example 14 | EVOH 4/Tie 4/PE 32 | unstretched | 90 | C | B | B | B |
| Example 15 | EVOH 4/Tie 4/PE 32 | unstretched | 90 | B | B | B | C |
| Example 16 | EVOH 4/Tie 4/PE 32 | unstretched | 90 | B | B | B | B |
| Example 17 | EVOH 4/Tie 4/PE 32 | unstretched | 90 | C | B | B | B |
| Example 18 | EVOH 4/Tie 4/PE 32 | unstretched | 90 | C | B | B | C |
| Example 19 | EVOH 4/Tie 4/PE 32 | unstretched | 90 | B | B | B | D |
| Example 20 | EVOH 4/Tie 4/PE 32 | unstretched | 90 | B | B | B | C |

*: cc/(m² · day · atm)

TABLE 3

| | Resin composition (A) | | | | | | | | |
|---|---|---|---|---|---|---|---|---|---|
| | gas barrier resin (a) | | | | polyolefin (b) | | | | |
| | | | Et | | | Et | degree of | | |
| | | | unit | melting | | unit | saponi- | MFR | |
| | type | resin | content | point | type | content | fication | g/10 | Mn |
| | — | — | mol % | ° C. | — | mol % | mol % | min | — |
| Example 21 | a-1C | EVOH | 32 | 183 | b-1 | 94 | 92 | 190 | 16,800 |
| Example 22 | a-1D | EVOH | 32 | 183 | b-1 | 94 | 92 | 190 | 16,800 |
| Example 23 | a-1A | EVOH | 32 | 183 | b-1 | 94 | 92 | 190 | 16,800 |
| Example 24 | a-1 | EVOH | 32 | 183 | b-1 | 94 | 92 | 190 | 16,800 |
| Example 25 | a-1 | EVOH | 32 | 183 | b-1 | 94 | 92 | 190 | 16,800 |
| Example 26 | a-1 | EVOH | 32 | 183 | b-1 | 94 | 92 | 190 | 16,800 |
| Example 27 | a-1 | EVOH | 32 | 183 | b-1 | 94 | 92 | 190 | 16,800 |
| Example 28 | a-1 | EVOH | 32 | 183 | b-1 | 94 | 92 | 190 | 16,800 |
| Example 29 | a-1 | EVOH | 32 | 183 | b-1 | 94 | 92 | 190 | 16,800 |
| Example 30 | a-1 | EVOH | 32 | 183 | b-1 | 94 | 92 | 190 | 16,800 |
| Example 31 | a-1 | EVOH | 32 | 183 | b-1 | 94 | 92 | 190 | 16,800 |
| Example 32 | a-5 | EVOH | 44 | 119 | b-1 | 94 | 92 | 190 | 16,800 |
| Example 33 | a-1 | EVOH | 32 | 183 | b-1 | 94 | 92 | 190 | 16,800 |
| Example 34 | a-6 | Ny 6/66 | — | 190 | b-1 | 94 | 92 | 190 | 16,800 |
| Example 35 | a-1 | EVOH | 32 | 183 | b-1 | 94 | 92 | 190 | 16,800 |
| Example 36 | a-1 | EVOH | 32 | 183 | b-1 | 94 | 92 | 190 | 16,800 |
| Comparative | — | — | — | — | — | — | — | — | — |
| Example 1 | | | | | | | | | |
| Comparative | a-1 | EVOH | 32 | 183 | — | — | — | — | — |
| Example 2 | | | | | | | | | |
| Comparative | a-1 | EVOH | 32 | 183 | b-1 | 94 | 92 | 190 | 16,800 |
| Example 3 | | | | | | | | | |
| Comparative | a-1 | EVOH | 32 | 183 | b-6 | 89 | 0 | 2.5 | — |
| Example 4 | | | | | | | | | |
| Comparative | a-6 | Ny 6/66 | — | 190 | — | — | — | — | — |
| Example 5 | | | | | | | | | |
| | | Resin composition (A) | | | | | | | |
| | | polyolefin | | | | | | Vapor-deposited | |
| | | (b) | alkali | | multivalent | | | inorganic | |
| | | content | metal | | metal | | thermo- | layer (I) | |
| | | parts | ion (c) | | ion (d) | | gravimetry | | average |
| | | by | type | content | type | content | W | type | thickness |
| | | mass | — | ppm | — | ppm | % | — | nm |
| | Example 21 | 2 | Na | 245 | Ca | 250 | 0.06 | — | — |
| | Example 22 | 2 | Na | 539 | Ca | 250 | 0.06 | — | — |
| | Example 23 | 2 | — | 0 | — | 0 | 0.06 | — | — |
| | Example 24 | 2* | Na | 176 | Ca | 250 | 0.06 | — | — |
| | Example 25 | 2 | Na | 176 | Ca | 250 | 0.25 | — | — |
| | Example 26 | 2 | Na | 176 | Ca | 250 | 0.40 | — | — |
| | Example 27 | 2 | Na | 176 | Ca | 250 | 0.06 | AlOx | 30 |
| | Example 28 | 2 | Na | 176 | Ca | 250 | 0.06 | SiOx | 30 |
| | Example 29 | 2 | Na | 176 | Ca | 250 | 0.06 | Al | 50 |
| | Example 30 | 2 | Na | 176 | Ca | 250 | 0.06 | — | — |
| | Example 31 | 2 | Na | 176 | Ca | 250 | 0.06 | — | — |
| | Example 32 | 2 | Na | 176 | Ca/Zn | 250/30 | 0.06 | — | — |
| | Example 33 | 2 | Na | 176 | Ca | 250 | 0.06 | — | — |
| | Example 34 | 2 | — | — | — | — | 0.06 | — | — |
| | Example 35 | 1 | Na | 178 | Ca | 250 | 0.06 | — | — |
| | Example 36 | 0.5 | Na | 179 | Ca | 250 | 0.06 | — | — |
| | Comparative | — | — | — | — | — | — | — | — |
| | Example 1 | | | | | | | | |
| | Comparative | — | Na | 180 | Ca | 250 | 0.06 | — | — |
| | Example 2 | | | | | | | | |
| | Comparative | 30 | Na | 138 | Ca | 250 | 0.06 | — | — |
| | Example 3 | | | | | | | | |
| | Comparative | 2 | Na | 176 | Ca | 250 | 0.06 | — | — |
| | Example 4 | | | | | | | | |
| | Comparative | — | — | — | — | — | 0.06 | — | — |
| | Example 5 | | | | | | | | |

*: dry blend

TABLE 4

| | Multilayer film/Vapor-deposited multilayer film | | | | | | |
|---|---|---|---|---|---|---|---|
| | | | PO | | oxygen | Recovered composition | |
| | layer configuration and | stretch ratio | thickness | die | transmission | | defects |
| | average thicknesses | MD × TD | proportion | buildup | rate | coloring | (recyclability) |
| | μm | — | % | — | * | — | — |
| Example 21 | EVOH 4/Tie 4/PE 32 | unstretched | 90 | B | B | B | B |
| Example 22 | EVOH 4/Tie 4/PE 32 | unstretched | 90 | B | B | C | D |
| Example 23 | EVOH 4/Tie 4/PE 32 | unstretched | 90 | C | B | B | D |
| Example 24 | EVOH 4/Tie 4/PE 32 | unstretched | 90 | C | B | B | B |
| Example 25 | EVOH 4/Tie 4/PE 32 | unstretched | 90 | C | B | B | B |
| Example 26 | EVOH 4/Tie 4/PE 32 | unstretched | 90 | D | B | B | B |
| Example 27 | AlOx (30 nm)/EVOH 4/Tie 4/PE 32 | unstretched | 90 | B | A | B | B |
| Example 28 | SiOx (30 nm)/EVOH 4/Tie 4/PE 32 | unstretched | 90 | B | A | B | B |
| Example 29 | Al (50 nm)/EVOH 4/Tie 4/PE 32 | unstretched | 90 | B | A | E | B |
| Example 30 | EVOH 10/Tie 5/PE 25 | unstretched | 75 | B | A | C | C |
| Example 31 | EVOH 4/Tie 4/PE 32 | 5 × 1 | 90 | B | A | B | B |
| Example 32 | EVOH 4/Tie 4/PE 32 | 4 × 8 | 90 | B | A | B | B |
| Example 33 | EVOH 4/Tie 4/PP 32 | unstretched | 90 | B | B | B | B |
| Example 34 | Ny 10/Tie 5/PE 25 | unstretched | 75 | C | D | B | D |
| Example 35 | EVOH 4/Tie 4/PE 32 | unstretched | 90 | C | B | B | B |
| Example 36 | EVOH 4/Tie 4/PE 32 | unstretched | 90 | D | B | B | B |
| Comparative | PE 40 | unstretched | 100 | A | E | A | A |
| Example 1 | | | | | | | |
| Comparative | EVOH 4/Tie 4/PE 32 | unstretched | 90 | E | B | B | B |
| Example 2 | | | | | | | |
| Comparative | EVOH 4/Tie 4/PE 32 | unstretched | 90 | B | D | C | E |
| Example 3 | | | | | | | |
| Comparative | EVOH 4/Tie 4/PE 32 | unstretched | 90 | E | B | B | B |
| Example 4 | | | | | | | |
| Comparative | Ny 10/Tie 5/PE 25 | unstretched | 75 | F | D | B | D |
| Example 5 | | | | | | | |

*: cc/(m² · day · atm)

1. A multilayer film comprising:
a layer (X) as an outermost layer; and
at least one layer different from the layer (X),
wherein
the layer (X) is a layer consisting only of a resin composition (A) comprising: at least one gas barrier resin (a) selected from the group consisting of a polyamide and a vinyl alcohol resin; and a polyolefin (b) having a melt flow rate of 3.0 g/10 min or more at 190° C. under a load of 2.160 kg, as measured in accordance with JIS K7210-1 (2014), and
the resin composition (A) comprises 0.1 parts by mass or more and 20 parts by mass or less of the polyolefin (b) with respect to 100 parts by mass of the gas barrier resin (a).

2. The multilayer film according to claim 1, wherein the gas barrier resin (a) is at least one selected from the group consisting of nylon 6/66 and an ethylene-vinyl alcohol copolymer.

3. The multilayer film according to claim 1, wherein the gas barrier resin (a) is an ethylene-vinyl alcohol copolymer having an ethylene unit content of 20 to 50 mol % and a degree of saponification of 90 mol % or more.

4. The multilayer film according to claim 1, wherein the polyolefin (b) has a melt flow rate of 10 g/10 min or more at 190° C. under a load of 2.160 kg, as measured in accordance with JIS K7210-1 (2014).

5. The multilayer film according to claim 1, wherein the polyolefin (b) is an ethylene-vinyl acetate copolymer having an ethylene unit content of 75 to 98 mol % or a saponified product thereof.

6. The multilayer film according to claim 5, wherein the polyolefin (b) is the saponified product of the ethylene-vinyl acetate copolymer, and the saponified product has a degree of saponification of 30 mol % or more.

7. The multilayer film according to claim 1, wherein a number-average molecular weight (Mn) of the polyolefin (b) is 3,000 to 25,000.

8. The multilayer film according to claim 1, wherein the resin composition (A) comprises an alkali metal ion (c) at a concentration of 40 ppm or more and 500 ppm or less.

9. The multilayer film according to claim 1, wherein the resin composition (A) comprises at least one type of multivalent metal ion (d) selected from the group consisting of a magnesium ion, a calcium ion, and a zinc ion, at a concentration of 20 ppm or more and 2,000 ppm or less.

10. The multilayer film according to claim 1, wherein the layer (X) is a layer obtained by melt forming pellets consisting only of the resin composition (A).

11. The multilayer film according to claim 1, comprising a layer (Y) and a layer (Z) as the layer different from the layer (X),
wherein
the layer (Y) comprises as a principal component, an adhesive resin (B) having a melting point of less than 170° C.;
the layer (Z) comprises as a principal component, a polyolefin resin (C) having a melting point of less than 170° C.; and
the multilayer film has a configuration in which the layer (X), the layer (Y), and the layer (Z) are laminated in this order.

12. The multilayer film according to claim 11, wherein the adhesive resin (B) is an acid-modified polyethylene or an acid-modified polypropylene.

13. The multilayer film according to claim 11, wherein the polyolefin resin (C) is a polyethylene or a polypropylene.

14. The multilayer film according to claim 1, wherein in thermogravimetry (TG), a weight loss W of the resin composition (A) after being maintained at 200° C. for 30 minutes in a nitrogen atmosphere is 0.01 to 0.3%.

15. The multilayer film according to claim 1, not comprising: a layer comprising as a principal component, a resin having a melting point of 200° C. or more; and a metal layer having an average thickness of 1 μm or more.

16. The multilayer film according to claim 1, wherein an average thickness of the layer (X) is 0.2 μm or more and less than 20 μm, and a proportion of the average thickness of the layer (X) with respect to an average thickness of the multilayer film is less than 25%.

17. The multilayer film according to claim 1, wherein the multilayer film is not stretched.

18. The multilayer film according to claim 1, wherein the multilayer film is only uniaxially stretched by 3 times or more and less than 12 times.

19. The multilayer film according to claim 1, wherein the multilayer film is biaxially stretched each by 3 times or more and less than 12 times.

20. The multilayer film according to claim 1, wherein a proportion of a total average thickness of a layer comprising a polyethylene resin or a polypropylene resin as a principal component is 75% or more.

21. A vapor-deposited multilayer film comprising:
the multilayer film according to claim 1; and
a vapor-deposited inorganic layer (I) laminated to an exposed-face side of the layer (X) of the multilayer film.

22. The vapor-deposited multilayer film according to claim 21, wherein the vapor-deposited inorganic layer (I) is: a vapor-deposited metal layer comprising aluminum as a principal component; or a vapor-deposited inorganic-oxide layer comprising alumina or silica as a principal component.

23. The multilayer film or the vapor-deposited multilayer film according to claim 1, having an oxygen transmission rate of less than 60 cc/(m²·day·atm), as measured in accordance with JIS K7126-2 (2006) under a condition involving 20° C. and 65% RH.

24. A multilayer structure in which: the multilayer film or the vapor-deposited multilayer film according to claim 1; and at least one resin layer (R) comprising a thermoplastic resin (D) as a principal component are laminated.

25. The multilayer structure according to claim 24, wherein the thermoplastic resin (D) is a polyethylene or a polypropylene.

26. A packaging material comprising the multilayer structure according to claim 24.

27. A recovered composition comprising a recovered material of the multilayer structure according to claim 24.

28. A method for recovering a multilayer structure, the method comprising:
melt forming the multilayer structure according to claim 24 or 25 after the multilayer structure is ground.

29. A method for producing the multilayer film according to claim 1, the method comprising:
melt kneading the gas barrier resin (a) and the polyolefin (b) to obtain pellets of the resin composition (A); and
melt forming the pellets of the resin composition (A) to form the layer (X).
